(19) United States
(12) Patent Application Publication
(10) Pub. No.: US 2009/0078893 A1
(43) Pub. Date: Mar. 26, 2009

(54) IMAGE READING APPARATUS

(76) Inventors: Masahiro Umemura, Tokyo (JP); Kazuhiro Sakino, Tokyo (JP); Takayuki Narita, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/912,472

(22) PCT Filed: Apr. 14, 2006
(86) PCT No.: PCT/JP2006/307900

§ 371 Date: Oct. 24, 2007

(30) Foreign Application Priority Data
Apr. 27, 2005 (JP) 2005-129481
Jul. 11, 2005 (JP) 2005-201743
Jul. 11, 2005 (JP) 2005-201989
Aug. 18, 2005 (JP) 2005-237539

(51) Int. Cl. G01N 23/02

(52) U.S. Cl. 250/589

(57) ABSTRACT

An image reading apparatus includes an optical unit for reading the image information by scanning and irradiating the photostimulable phosphor plate with the excitation light from a light source and converging photo-stimulated luminescence light emitted from the photostimulable phosphor plate to conduct photoelectric conversion, a base table, a linear motor for moving the optical unit with respect to the base table, a wire fixed on the base table at both ends of the wire, a pulley rotatably fixed on the optical unit for being rotated by relative movement between the pulley and the wire caused by the movement of the optical unit, a rotary encoder for detecting a rotational speed of the pulley; and a control section for controlling the linear motor based on a detection result of the rotary encoder, wherein the wire is wound not less than one turn around the pulley and inclined at a predetermined angle against a line crossing a rotational axis of the pulley at right angle.

### FIELD OF THE INVENTION

This invention relates to an image forming apparatus, particularly relates to an image reading apparatus including a shaft type linear motor having a superiority in scan-conveyance capability of a photostimulable phosphor plate, which is suitable for the usage in a medical field and a printing field.

### BACKGROUND

Radiographic images such as X-ray images are used extensively for diagnosis of illness. Conventionally, in order to obtain such radiographic images, the so-called radiographs were used in which the X-rays passing through the subject impinged on a phosphor layer (fluorescent screen) thereby generated visible light, and this visible light impinged on a film using silver salts as in normal photography and this film was developed. However, in recent years, methods that use no films coated with silver salts but directly take out images from the phosphor layer have been devised.

In an example of such a method, the radiation that has passed through the subject such as the patient's body is made to be absorbed by a phosphor. After that, this phosphor is, for example, excited by light or thermal energy thereby emits the radiation energy accumulated in the phosphor due to the above absorption, as fluorescent light, and finally this light is detected to generate the image. This is an example using a stimulable phosphor plate which is prepared by forming a stimulable phosphor layer on a base support. The radiographic image is obtained as digital image data by making the radiation that has passed through the subject impinge on the stimulable phosphor layer of this stimulable phosphor plate and forming a latent image by accumulating the radiation energy corresponding to the radiation transmittance of each part of the subject. Thereafter, the radiographic image is obtained by emitting the radiation energy accumulated in each part by scanning this stimulable phosphor layer with a stimulation exciting light beam, and converting this energy into light, and converting the intensity variations of this light into image data using a photoelectric conversion device such as a photomultiplier, etc.

Based on such digital image data, image formation is made on a silver halide film sheet or the image is outputted on a CRT, etc., thereby making it visible. In addition, the digital image data is stored in an image storage device such as a semiconductor storage device, a magnetic storage device, or an optical disk storage device. Thereafter, it can be read out from the image storage device when necessary and can be converted into a visible form using a silver halide film or a CRT display, etc.

However, when scanning a stimulable phosphor plate with a stimulation exciting light beam, the image reading section (the optical unit) should be moved accurately at a constant speed relative to the stimulable phosphor plate. Therefore, in conventional arts, methods to convey a conveyed body by using a linear motor, a rotary encoder and wire has been disclosed. (for example, Patent document No. 1)

A prior art discloses a method for conveying a conveyance body by using a linear motor, a rotary encoder, a pulley connected to rotational shaft of the rotary encoder and a wire rope wound around the pulley. (for example, refer to patent document No. 2)

However, in the conveyance mechanism, two guide members hold the conveyance body so as to be capable of sliding and reciprocally moving on a straight line. It is not suitable on the viewpoint of minimization of an apparatus and cost reduction. Thus, a technology for holding the conveyance body by one guide member and using a shaft type linear motor as a conveyance device has been known (for example, refer to a patent document No. 3).

The shaft type linear motor includes a stator structured by a plurality of magnets serially assembled so that opposite magnetic poles are opposed to each other and a moving element including a coil, which is capable of sliding in the shaft direction of the stator, with the moving element being disposed outside the stator so as to surround the stator. By turning on electric current in the coil so as to cross magnetic fluxes generated by the magnet, a driving force is generated with the coil in the shaft direction based on a mutual action between electric current and magnetic field. As a result the moving element moves.

In the shaft type linear motor like this, so far, in case when fixing magnets repelling each other closely, the magnets have been fixed by passing a shaft through the center of cylindrical shape magnets and sandwiching the magnets by using screws by providing screw sections at the ends of the shaft (for example, refer to patent document No. 4).

Patent document No 1: Japanese Patent Application Open to Public Inspection No. H09-222318

Patent document No 2: Japanese Patent Application Open to Public Inspection No. H09-222318

Patent document No 3: Japanese Patent Application Open to Public Inspection No. 2005-70533

Patent document No 4: Japanese Patent Application Open to Public Inspection No. H10-313566

### DISCLOSURE OF THE INVENTION

### Problems to be Solved by the Present Invention

In order to scan the photostimulable phosphor plate by photostimulable excitation light, the conveyance body is conveyed. In this case, the constant speed of conveyance body is required and high performance of speed control is required. However, in the technology disclosed by the patent document No. 1, a rotary encoder and a wire conduct a position detection of the linear motor. However, there is no description about constant speed and there is a possibility that the required constant speed conveyance performance cannot be obtained by only the position detection. Thus, the conveyance speed irregularity of the conveyance body becomes worse, and image irregularity occurs when scanning the photostimulable prosper plate by photostimulable exciting light. There was a case that a diagnosis image caused trouble due to this image irregularity.

Further, in case when structuring the image reading apparatus disclosed in the patent document No. 2 so that the conveyance body moves on the horizontal surface, the problem of conveyance irregularity (image irregularity), which did not occur under the vertical conveyance structure of the patent document No. 2, has occurred. In other words, since the image reading apparatus is horizontally conveyed by one guide member, the conveyance body receives rotational force in a yawing direction according to the position of the guide member and the linear motor. Accordingly, there has been a problem that the conveyance irregularity associated with the rotational movement in a yawing direction and the conveyance irregularity caused by the disturbance of the leaked magnetic flux of the linear motor become large and cause the deterioration of the conveyance performance.

In case when using a magnet having a cylindrical shape for the shaft type linear motor of an image reading apparatus, in order to hold the repelling magnet with the magnet having a hole in the center of the magnet has been used. Since the number of parts pertaining to the structure for passing a shaft through the center hole of the magnet and connecting each other is large and cost is high, the shaft type linear motor having a simple structure, in which the repelling magnet is easily and simply stored, has been required.

Therefore an object of the present invention is to provide an image reading apparatus using a shaft type linear motor, which is capable of obtaining a superior diagnosis image without having image irregularity, and in which the constant velocity characteristic has been improved in order to solve the problems described above.

It is another object of the present invention to provide an image reading apparatus and an image forming apparatus, which are capable of providing a shaft magnet disposing position of a shaft type linear motor even though having a guide member for guiding the conveyance body reciprocally traveling on a straight line on a horizontal surface, and capable of obtaining a high quality image by decreasing image irregularity.

### Means for Solving the Problems

These and other objects of the present invention will be attained by a following configuration.

1. An image reading apparatus for reading image information by irradiating a photostimulable phosphor plate with excitation light, onto which a photostimulable phosphor sheet is attached, the image reading apparatus including

an optical unit for reading the image information by scanning and irradiating the excitation light from a light source to the photostimulable phosphor plate and converging photo-stimulated luminescence light emitted from the photostimulable phosphor plate to conduct photoelectric conversion,

a linear motor for moving the optical unit,

a wire for moving together with the optical unit,

a pulley for being rotated based on the movement of the optical unit, which is transmitted via the wire,

a rotary encoder for detecting a rotational speed of the pulley, and

a control section for controlling the linear motor based on a detection result of the rotary encoder,

wherein the wire is wound not less than 1 turn around the pulley, the wire being inclined at a predetermined angle against a line crossing a rotational axis of the pulley at right angle.

2. An image reading apparatus for reading image information by irradiating a photostimulable phosphor plate with excitation light, onto which a photostimulable phosphor sheet is attached, the image reading apparatus including,

an optical unit for reading the image information by scanning and irradiating the excitation light from a light source to the photostimulable phosphor plate and converging photostimulable luminescence light emitted from the photostimulable phosphor plate to conduct photoelectric conversion,

a linear motor for moving the photostimulable phosphor plate,

a wire for moving together with the photostimulable phosphor plate,

a pulley for being rotated based on the movement of the photostimulable phosphor plate, which is transmitted via the wire,

a rotary encoder for detecting a rotational speed of the pulley, and

a control section for controlling the linear motor based on a detection result of the rotary encoder,

wherein the wire is wound not less than 1 turn around the pulley, the wire being inclined at a predetermined angle against a line crossing a rotational axis of the pulley at right angle.

3. The image reading apparatus of item 1 or item 2,

wherein when the predetermined angle is assumed to be θ, the wire is wound around the pulley based on a following relation,

tan⁻¹(2×2r/2πR)≧θ≧tan⁻¹(2r/2πR)

r: radius of wire, R: radius of pulley

4. The image reading apparatus of any one of items 1-3,

wherein the rotational shaft of the rotary encoder and the pulley are integrally structured.

5. The image reading apparatus of any one of items 1-4,

wherein a surface hardness of the pulley is not less than a surface hardness of a material of the wire.

### EFFECTS OF THE INVENTION

According to the image reading apparatus of the present invention, an optical unit or a photostimulable phosphor plate can be moved at a constant speed to improve a constant speed capability. Further, a preferable image without irregularity can be obtained when scanning the photostimulable phosphor plate by excitation light.

Further, according to the image reading apparatus and the image forming apparatus including the image reading apparatus of the present invention, a conveyance characteristic can be improved and a high quality image can be obtained by decreasing image irregularity.

Particularly, according to item (1), since the rub between wires does not occur and a load fluctuation of the pulley can be controlled, the pulley can be rotated with a constant speed. Further, since the rub between the wires does not occur, the durability of the wire itself can be improved.

According to item (2), since the rub between wires does not occur and a load fluctuation of the pulley can be controlled, the pulley can be rotated with a constant speed. Further, since the rub between the wires does not occur, the durability of the wire itself can be improved.

According to item (3), the contact between wires does not happen on the pulley so the rub between wires does not occur.

According to item (4), since the rotational shaft of a rotary encoder and the pulley are integrally formed, the eccentricity caused by the rotation can be suppressed, and the rotary encoder can be rotated with a further constant speed.

According to item (5), by setting a surface hardness of the pulley not less than a surface hardness of a material of the wire, the abrasion of the pulley can be suppressed and durability of the pulley itself can be improved. At the same time, the deterioration of the constant speed rotation caused by the abrasion can be suppressed.

### BRIEF DESCRIPTION OF THE DRAWINGS

FIG. 1 illustrates a perspective view of a conveyance mechanism of an image reading apparatus of the present invention.

FIG. 2 illustrates an X-Z plane view of the conveyance mechanism of FIG. 1.

FIG. 3 illustrates an X-Y plane view of the conveyance mechanism of FIG. 1.

FIG. 4 illustrates a Y-Z plane view of the conveyance mechanism of FIG. 1.

FIG. 5 illustrates a block diagram showing a speed control section of the image reading apparatus.

FIG. 6 illustrates a magnification drawing of a rotary encoder unit in FIG. 3 and a situation where wire is wound around the pulley.

FIG. 7 illustrates a second embodiment of the present invention, and which is a perspective view of a conveyance mechanism of an image reading apparatus.

FIG. 8 illustrates an X-Z plane view of the conveyance mechanism of FIG. 7.

FIG. 9 illustrates an X-Y plane view of the conveyance mechanism of FIG. 7.

FIG. 10 illustrates a Y-Z plane view of the conveyance mechanism of FIG. 7.

FIG. 11 illustrates a block diagram showing a feedback control of the image reading apparatus.

FIGS. 12(a)-12(c) schematically illustrate a position relationship between a guide rail, a guided member, the magnet section of a linear motor, wire rope and a rotary encoder.

FIGS. 13(a)-13(c) illustrate an modified example and schematically illustrate a position relationship between a guide rail, a guided member, the magnet section, wire rope, a rotary encoder and photoelectric converter.

FIG. 14 illustrates a graph showing a horizontal direction distance Xz between a guide rail and a magnet section in the lateral axis and the amplitude of conveyance irregularity in a vertical axis.

FIG. 15 illustrates a graph showing a distance X between a guide rail and a magnet section in the lateral axis and the amplitude of conveyance irregularity in a vertical axis.

FIG. 16 illustrates a graph showing a distance Xp between a photoelectric converter and a magnet section in the lateral axis and the amplitude of conveyance irregularity in a vertical axis.

FIG. 17 illustrates a graph showing a distance Xw between the wire rope and a magnet section in the lateral axis and the amplitude of conveyance irregularity in a vertical axis.

FIG. 18 illustrates a schematic diagram of a manufacturing apparatus of a shaft type linear motor.

FIG. 19 illustrates a magnification view of a fixing table section.

FIG. 20 illustrates a cross sectional view along the line III-III in FIG. 19.

FIG. 21 illustrates a cross sectional view of a fixing section of a sealing member for a rear end section of the shaft type linear motor.

FIG. 22 illustrates a front view of a fixing section of a sealing member for a rear end section of the shaft type linear motor.

FIG. 23 illustrates a schematic diagram of the shaft type linear motor.

FIG. 24 illustrates a manufacturing process of a moving element.

FIG. 25 illustrates a perspective view of a cylindrical member having a brim.

FIG. 26 illustrates a perspective view of the cylindrical member having a brim, around which a wire has been wound.

FIG. 27 illustrates a wire connection of the coil.

FIG. 28 illustrates a perspective view of the structure of a connection of multiple cylindrical members having brims and coils.

FIG. 29 illustrates a moving element adhesive fixing process.

FIG. 30 illustrates a perspective view of situation where a fixing member and an attaching member are combined.

FIG. 31 illustrates a perspective view of a situation where a shaft shaped member is installed, while a moving element has been inserted into an assembled fixing member and the attached member.

FIG. 32 illustrates a perspective view of a situation where positioning is conducted while holding the moving element.

FIG. 33 illustrates a cross sectional view of a situation where the moving element has been attached.

FIG. 34 illustrates a cross sectional view along a line of XII-XII in FIG. 33, from which the fixing member has been omitted.

FIG. 35 illustrates a cross sectional view at the same position as FIG. 33 to which adhesive has been filled.

FIG. 36 illustrates a cross sectional view along a line of XIV-XIV in FIG. 35, from which the fixing member has been omitted.

FIG. 37 illustrates a perspective view of a situation where a shaft shaped member is being removed.

FIG. 38 illustrates a cross sectional view of a situation where the moving member has been fixed into the attaching member.

FIG. 39 illustrates a cross sectional view of the other embodiment at the same position as FIG. 33 to which adhesive has been filled.

FIG. 40 illustrates a perspective view of structural parts of the moving element.

FIG. 41 illustrates a connection drawing of the coil.

FIG. 42 illustrates a perspective view showing an embodiment of a radiation image reading apparatus.

### DESCRIPTION OF THE SYMBOLS

A Line crossing at right angle
P Photostimulable phosphor plate (a recording medium, a conveyance body)
1 Optical unit
6 Wire
7 Linear motor
12 Photoelectric converter (photomultiplier)
31 Guide rail (Guide member)
32 Guided member
33 Traveling board (conveyance body)
51 Rotary encoder
52 Pulley
71 Magnet section (shaft style magnet)
100 Speed control section (control device)
101 Shaft type linear motor manufacturing apparatus
102 Apparatus main body
103 Fixing table
104 Pipe style member
105 Magnet
110 Inserting mechanism
111 Trapezoidal screw
112 Support table
120 Shaft type member
130 Receiving table
130a Stopper surface
131 Magnet storage member
132 Shutter
140, 60 Sealing member
210 Shaft type linear motor
220 Stator
221 Pipe style member
224 Magnet
225 Attaching member
230 Moving element

### DESCRIPTION OF THE PREFERRED EMBODIMENT

The first to second preferred embodiments of the present invention are described in the following while referring to the drawings.

Further, in the present invention, since the stimulable phosphor sheet alone does not have rigidity and its handling within the apparatus is difficult, it is uncommon to handle the stimulable phosphor sheet by itself, and very often it is affixed to a base support such as a metal plate or a resin plate, and is supported by affixing on the inside of a case called a cassette that can be installed or removed easily. In the following explanations, the configuration of the stimulable phosphor sheet supported by the base support or cassette in this manner will be referred to as a stimulable phosphor plate. Further, this stimulable phosphor plate is supported by mounting its base support side on a fixing plate with rubber magnet or the like.

This stimulable phosphor plate absorbs the radiation that are passed through the body of the subject during radiographing, and a part of that energy is stored as the information of the radiographic image within the stimulable phosphor. The image reading apparatus according to the present invention is an apparatus that reads out the information of the radiographic image accumulated within the stimulable phosphor in this manner.

### First Preferred Embodiment

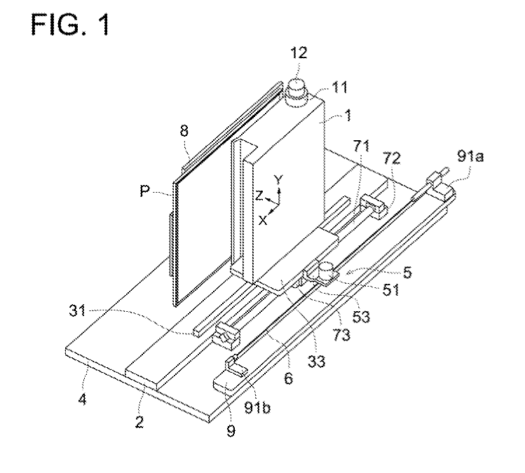

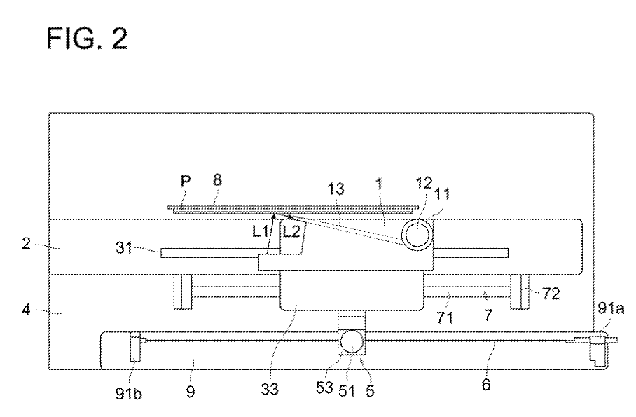

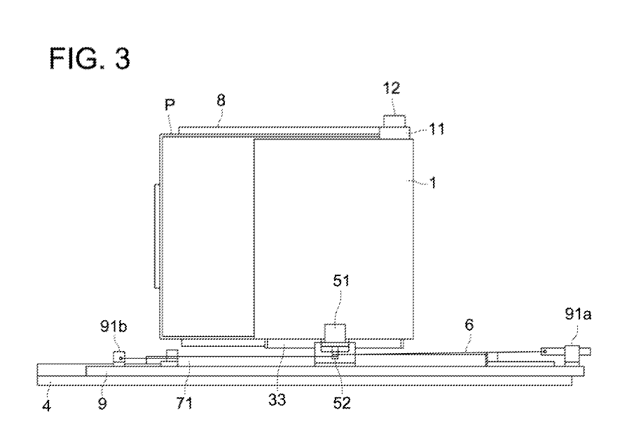

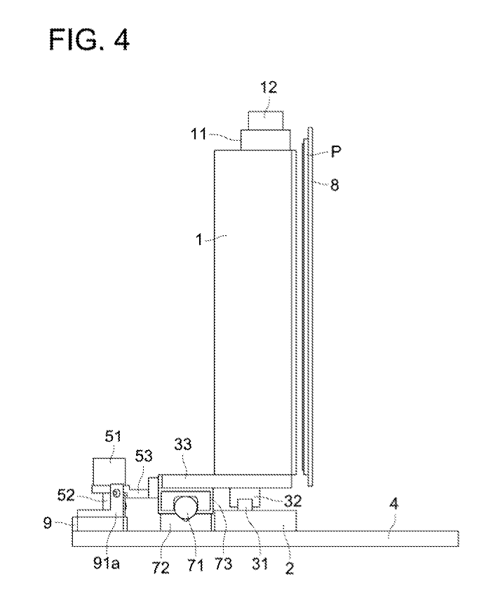

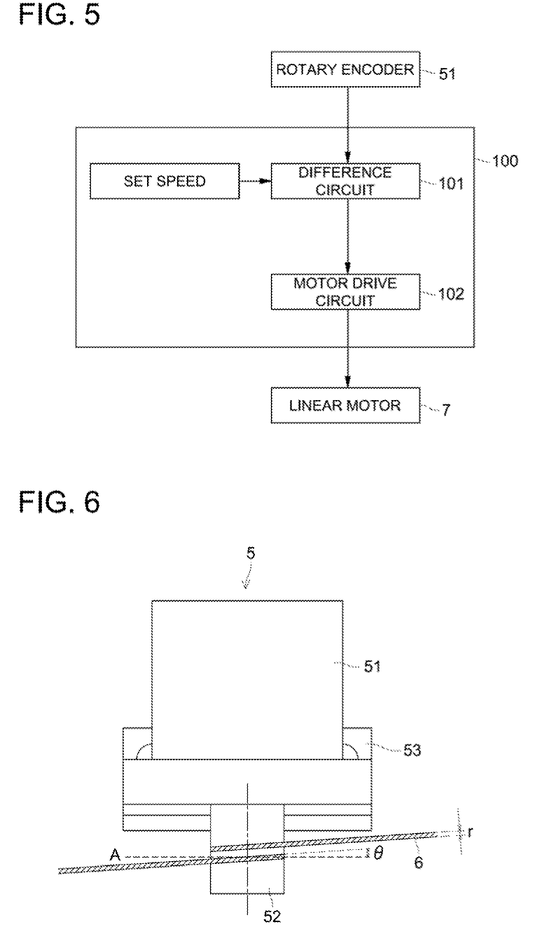

FIG. 1 shows the perspective view of the transport mechanism in an image reading apparatus according to the first preferred embodiment of the present invention, FIG. 2 is an X-Z plane plan view diagram of the transport mechanism of FIG. 1, FIG. 3 is an X-Y plane plan view diagram of the transport mechanism of FIG. 1, FIG. 4 is an Y-Z plane plan view diagram of the transport mechanism of FIG. 1, and FIG. 5 is a block diagram showing the speed control section of image reading apparatus.

As is shown in FIGS. 1 to 4, the image reading apparatus is provided with an optical unit 1 that illuminates the stimulable phosphor plate P with laser light (excitation light) from the laser light emitting apparatus (light source) (not shown in the figure) while scanning it and reads the image information by condensing the photo-stimulated luminescence light emitted from the stimulable phosphor plate P and carrying out photoelectric conversion of this light. The image reading apparatus is also provided with a support member 2 that is provided on a base table 4 and supports the optical unit 1 so that it is free to move in the horizontal direction. It is also provided with a linear motor 7 that moves the optical unit 1, and a guide rail 31 that is provided on a support member 2 and guides the optical unit 1 in the horizontal direction.

An image reading apparatus includes wire 6 and a rotary encoder unit 5, which move together with an optical unit 1, and are connected with a traveling board 33, onto which the optical unit 1 has been attached, a pulley 52, which rotates due to the transmission of the movement of the optical unit 1, a rotary encoder unit 51 for detecting the rotational speed of the pulley 52 and a speed control section (a control device) 100 for controlling a linear motor 7 by comparing detected results of the rotary encoder 51 with a setting speed set in advance.

Respective structuring members will be described in detail hereinafter.

A base table 4 has a substantially rectangular shape. A fixing plate 8 for supporting the photostimulable phosphor plate P is fixed onto the base table 4. The photostimulable phosphor plate P is held on the base table 4 so that the laser irradiated surface of the photostimulable phosphor plate P is substantially perpendicular to the top surface of the base table 4.

Further, an optical unit 1 is disposed opposed to this photostimulable phosphor plate P. A traveling board 33 is attached onto the lower surface of the optical unit 1 and the traveling board 33 is capable of moving against the base table 4. Thus, the optical unit 1 is capable of moving against the base table 4.

A support member 2 that is of the shape of a long plate that extents in the horizontal direction and that has been fixed so that it is approximately horizontal at nearly the center of the top surface of the base table 4. The guide rail 31 that guides the optical unit 1 in the horizontal direction is provided on the top surface of this support member 2.

The guide rail 31 is a bar-shaped member with an approximately rectangular-shaped cross section, and as is shown in FIG. 4, it mates with a guided member 32 that is guided by the guide rail 31 and has an approximately U-shaped cross section. The guided member 32 is affixed to a bottom surface of the moving plate 33.

In this manner, the optical unit 1 is supported on the base 4 by the support member 2, the guide rail 31, the guided member 32, and the moving plate 33, and is placed opposing the stimulable phosphor plate P.

Further, a linear motor supporting member 72 is provided on the top surface of the base table 4 and on the side on the support member 2 to support the magnet section 71 constituting the linear motor 7. The magnet section 71 is formed in the shape of a shaft by linking either the N poles or the S poles of a plural number of permanent magnets with circular cross sections.

Further, the magnet section 71 is provided with a movable coil 73 that constituents a linear motor 7. The movable coil 73 has a coil formed in a shape of a cylinder, and the coil is covered by a box-shaped covering member. Further, the movable coil 73 is provided on the bottom surface of the movable plate 33, and the linear motor 7 is configured so that the magnet section 71 passes through the center of the movable coil 73.

A holding member 9 having a longitudinal plate shape extending in a horizontal direction in parallel with a support member 2 is fixed so as to be in substantially horizontal in the side direction of linear motor holding sections 72 on the upper surface of the base table 4. As illustrated in FIG. 1, fixing members 91a and 91b having a substantially L-character shape in a cross sectional view are provided in the longitudinal direction at both ends of the upper surface of holding member 9. The both ends of wire 6 are fixed onto these fixing members 91a and 91b so as to become different in terms of height. A rotary encoder unit 5 is connected with the wire 6. In FIG. 1, the right side end of the wire 6 is fixed on the fixing member 91a so as to be higher than the left side end. Based on this arrangement, as described later, since the wire 6 wound around the pulley 52 does not contact with the wire 6 itself, abrasion does not occur and the wire 6 can be obliquely wound around the pulley 52 not less than one (1) turn.

The rotary encoder unit 5 includes a support table 53, which is attached to the traveling board 33 and is capable of moving together with the traveling board 33, a rotary encoder 51 provided on the support table 53 and a pulley 52, which is jointed to a rotational shaft (not shown) of the encoder 51 and attached to the lower surface of the support table 53. The rotary shaft of the rotary encoder 51 and the pulley 52 are formed into a unified body shape as described above. In other words, the rotational axis of the rotary encoder 51 and the rotational axis of pulley 52 have the same axis. By adopting a unified body shape, it becomes possible to suppress the eccentricity caused by rotation and to rotate the rotary encoder 51 with further constant speed.

FIG. 6 illustrates the situation where the wire 6 is wound around the pulley 52. The wire 6 fixed onto the fixing members 91a and 91b so that the heights of the both ends are different each other is wound around the pulley 52 with a slant state not less than one (1) turn (in FIG. 6, the wire is wound one turn) so that the angle between the line A crossing the rotational axis of the pulley 52 at right angle and the wire 6 becomes a predetermined angle θ. Here, the predetermined angle θ preferably satisfies the following formula (1) to the line A crossing the rotational axis of the pulley 52 at the right angle.

tan⁻¹(2×2r/2λR)≧θ≧tan¹(2r/2πR) (1)

Where “r” denotes the radius of the wire and “R” denotes the radius of the pulley.

By winding the wire 6 around the pulley 52 based on this relationship described above, there is no chance the wire 6 contacts with wire 6 itself on the pulley 52. Thus, the abrasion between wires 6 can be prevented. Here, a value of upper limit of θ is geometrically restricted by the disposure of the structure.

Further, the wire 6 is adjusted by the fixing members 91a and 91b so that the tension becomes a predetermined value.

With respect to the material of the pulley 52, iron or stainless material is preferred. With respect to the material of the wire 6, the material whose surface hardness is not more than that of the pulley 52, such as a material formed by stainless material, which is coated with resin, such as nylon, is preferred. The abrasion of the pulley 52 can be suppressed by setting the surface hardness of the pulley 52 not less than the surface hardness of the wire 6. Further, the durability of the pulley 52 itself can be improved and at the same time the deterioration of the constant speed rotation due to the abrasion can also be suppressed.

The wire 6 wound around the pulley 52 is arranged to move in a horizontal direction with the movement of the optical unit 1 and the traveling board 33. The rotary encoder 51 detects the rotation speed from rotating pulley 52 and rotational shaft of the rotary encoder 51 based on the movement of the wire 6. The detected rotation speed information is outputted to the speed control section 100 for controlling the rotation speed of the linear motor 7.

The speed control section 100, as is shown in FIG. 5 is provided with a difference circuit 101 and a motor drive control circuit 102. The above mentioned rotational speed information corresponding to the movement speed along the horizontal direction of the stimulable phosphor plate P is inputted to the difference circuit 101. Further, the difference circuit 101 processes this rotational speed information and outputs the rotational speed signal, and generates the differential signal by comparing with the set speed signal obtained from the set speed that has been set beforehand. This is outputted as the control signal to the motor drive circuit 102. The motor drive circuit 102 controls the linear motor 7 based on the differential signal.

On the other hand, this optical unit 1 has a laser light emitting apparatus that illuminates the stimulable phosphor plate P with the laser light L1 while scanning in a direction at right angles to the direction of movement of the stimulable phosphor plate P, a light guide plate 13 that guides the photo-stimulated luminescence light L2 that was excited because the stimulable phosphor plate P was illuminated by the laser light L1 from the laser light emitting apparatus, a light collecting tube 11 that condenses the photo-stimulated luminescence light L2 guided by the light guide plate 13, and a photoelectric converter 12 that converts the photo-stimulated luminescence light L2 condensed by the light collecting tube 11 to electrical signals.

Further, in the image reading apparatus of the present invention, although not shown in the figure, an deletion apparatus is provided that emits deletion light towards the stimulable phosphor plate P after the processing is completed of reading the radiation energy by the optical unit 1 in order to release the radiation energy remaining in the stimulable phosphor plate P.

Next, the operation of the image reading apparatus constituted as described above is explained in the following.

The stimulable phosphor plate P is taken inside the image reading apparatus by the transporting device, and is fixed to the fixing plate 8. At the time of reading an image, to begin with, the linear motor 7 is driven, and the traveling board 33 supporting the optical unit 1 is moved in the horizontal direction along the guide rail 31.

Because of this, the optical unit 1 is moved to a position opposite to the laser light emitted surface of the stimulable phosphor plate P and is scanned by the laser light from the laser light emission apparatus due to the horizontal movement of the stimulable phosphor plate P. At this time, the laser light is emitted while being scanned in a direction at right angles to the direction of movement of the optical unit 1. As a consequence, the photo-stimulated luminescence light is guided by the light guide plate 13 and is condensed by the light collecting tube 11, and is converted into electrical signals by the photoelectric converter 12.

Because the optical unit 1 moves in the horizontal direction in this manner, this movement is transmitted to the wire 6 via the support base 53 of the rotary encoder unit 5 provided on the traveling board 33, and the pulleys 52 and the shaft of the rotary encoder 51 rotate accordingly. At this time since wire 6 is wound around the pulley 52 one turn or more turns according to the condition of above equation (1), the wire 6 does not contact itself on the pulley 52 and the pulley 6 can be rotated stably at a constant speed. In association with this, the speed of this rotation is detected by the rotary encoder 51 coupled to the rotating shaft, and the result of this detection is outputted to the speed control section 100.

The rotational speed detected by the rotary encoder 51 is compared with the set speed signal obtained from the set speed that has been set beforehand in the differential circuit 101, and according to that result, the motor drive circuit 102 controls the drive of the linear motor 7.

Further, a widely known method is used as the driving method of the linear motor 7. For example, it is possible to control the speed of movement of the linear motor 7 by varying the frequency and voltage of the AC drive current by inverter control. Also, using PWM control, it is also possible to carry out the control using the pulse width of the pulse voltage to be inputted to the movable coil of the linear motor 7. Further, if it is a stepping motor, it is possible to control the movement speed by setting the period of the pulse to be inputted to the linear motor 7.

In this manner, by continuously detecting the speed of the rotary encoder 51, and by carrying out speed control of the linear motor 7 based on the result of that detection, it is possible to maintain a constant movement speed of the stimulable phosphor plate P. Therefore, it is possible to excite uniformly the radiation energy accumulated in the stimulable phosphor plate P, and to obtain favorable images without image non-uniformity.

The linear motor 7 is stopped when the processing of reading by the optical unit 1 is completed up to one end of the stimulable phosphor plate P.

After that, deletion light is emitted towards the stimulable phosphor plate P by an deletion apparatus not shown in the figure, and because of this, the radiographic image remaining in the stimulable phosphor plate P is erased. Thereafter, the stimulable phosphor plate P is transported to outside the image reading apparatus by the transporting device.

In case when the apparatus has not been operated for a long time, there may be a case that the wire 6 forms a curly shape along the pulley 52, since the wire 6 is wound around the pulley 52. In order to remove the curly shape of the wire 6, it is preferable that a moving operation is conducted before starting a reading operation.

According to the first embodiment of the image reading apparatus of the present invention, the wire 6 is wound around the rotational shaft of the pulley 52 with a slant state not less than 1 (one) turn so that the wire 6 is declined with a predetermined angle θ against a line A crossing a rotational axis of the pulley 52 at right angles. The abrasion of wires 6 themselves does not occur and the load fluctuation to the pulley 52 can be suppressed. Accordingly, the pulley 52 can rotate with a constant rotational speed. As a result, the constant speed capability can be improved by moving the optical unit 1 with a constant speed. Further, in case when scanning the photostimulable phosphor plate P by excitation light, a superior image without irregularity can be obtained.

Further, since the abrasion of wires 6 themselves do not occur, the durability of wire 6 itself can be improved.

### Second Embodiment

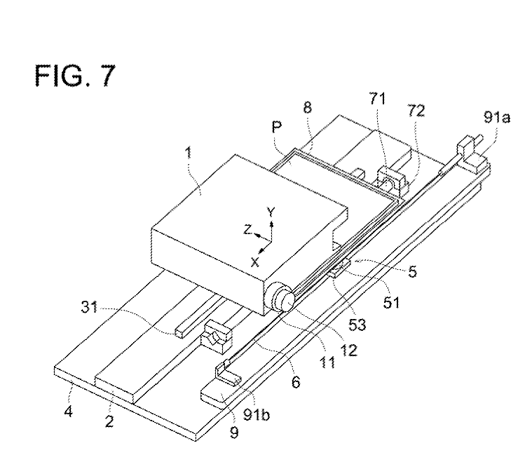

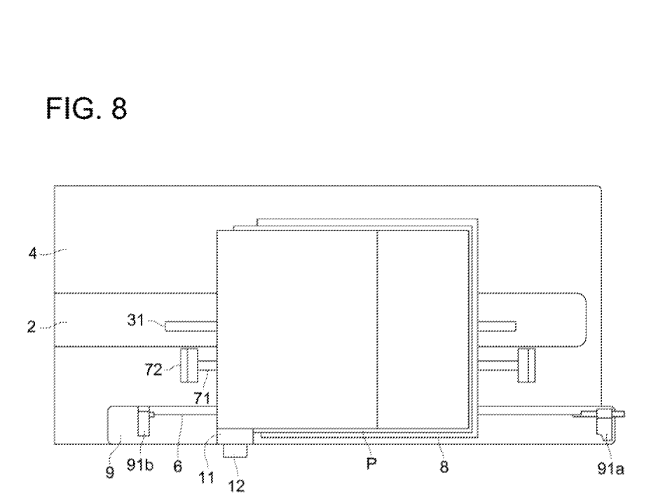

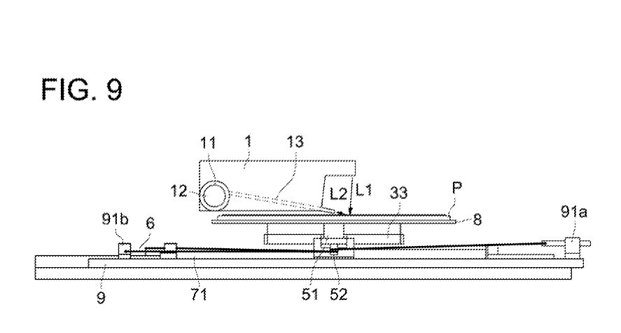

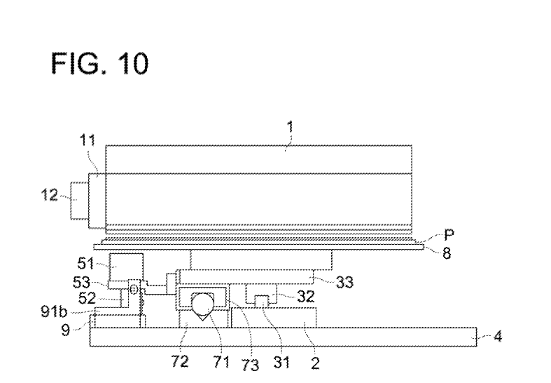

FIG. 7 illustrates a perspective view of a conveyance mechanism of an image reading apparatus of a second embodiment of the present invention. FIG. 8 illustrates an X-Z plane view of FIG. 7. FIG. 9 illustrates an X-Y plane view of FIG. 7. FIG. 10 illustrates a Y-Z plane view of FIG. 7.

In the image reading apparatus of the second embodiment of the present invention, being different from the first embodiment, the optical unit 1 is fixed onto the base table 4 and the photostimulable phosphor plate P is structured so as to move in the horizontal direction.

In other words, as illustrated in FIGS. 7-10, the optical unit 1 is disposed opposed to the upper surface of the base table 4 and the photostimulable phosphor plate P is disposed between the base table 4 and the optical unit 1. The fixing plate 8 attached on the lower surface of the photostimulable phosphor plate P is fixed on the traveling board 33, which is able to move against the base table 4. As a result, the optical unit 1 is able to move against the base table 4.

The same symbols will be given to the structural parts described below, which are the same structural parts as the first embodiment.

A support member 2 is provided on the substantially center of the base table 4 and a guide rail 31 is disposed on the support member 2. A guided member 32 is engaged with the guide rail 31 and the guided member 32 is attached to the lower surface of the traveling board 33.

The photostimulable phosphor plate P is supported by the support member 2, the guide rail 31, the guided member 32 and the traveling board 33 on the base table 4. The photostimulable phosphor plate P is disposed opposed to the optical unit 1.

Further, a linear motor 7, a linear motor support section 72, a magnet section 71 and a moving coil 73, which are the same as the first embodiment, are provided on the base table 4. Also a support member 9 and fixing member 91a and 91b are provided on the base table 4. The both ends of wire 6 are fixed with the fixing members 91a and 91b so as to become different in terms of height. A rotary encoder unit 5 is connected with the wire 6.

As the same as the first embodiment, the rotary encoder unit 5 includes a support table 53, which is fixed to the traveling board 33, a rotary encoder 51 and a pulley 52. The rotational shaft of the rotary encoder 51 and the pulley 52 have a unified body shape.

The wire 6 is wound around the rotational axis of the pulley 52 with a slant state not less than one (1) turn so that the wire is declined with a predetermined angle θ against a line A crossing a rotational axis of the pulley 52 at right angle. The predetermined angle θ is arranged to satisfy the relationship of formula (1).

Other than this, in the second embodiment, as the same as the first embodiment, the speed control section 100 is provided and the optical unit 1 has also the same function as the first embodiment.

Next, the operation of the image reading apparatus, having the structure as described above will be described.

The photostimulable phosphor plate P is taken inside the image reading apparatus by the conveyance device and fixed onto the fixing plate 8. When conducting the reading process of the image, firstly, the linear motor 7 is driven to move the traveling board 33, which supports the photostimulable phosphor plate P, along the guide rail 31 in the horizontal direction.

Based on this operation, the photostimulable phosphor plate P is moved to the position opposed to the laser irradiating surface of the optical unit 1. The laser beam emitted from a laser beam irradiating apparatus scans the photostimulable phosphor plate P while the photostimulable phosphor plate P is moved along the horizontal direction on the optical unit 1. At this moment, the laser beam is irradiated onto the photostimulable phosphor plate P while the photostimulable phosphor plate P is scanned in the direction, which is perpendicular to the moving direction of the optical unit 1. As a result, excited photostimulable luminescence light is guided by a light guide plate 13 to be converged onto a light collecting tube 11 and converted into electric signals by the photoelectric converter 12.

As described above, by moving the photostimulable phosphor plate P in the horizontal direction, the movement is transmitted to the wire 6 through the support table 53 of the rotary encoder unit 5 provided on the traveling board 33. As a result, pulley 52 and the rotational shafts of rotary encoder 51 are rotated. At this moment, since the wire 6 is wound around the pulley 52 not less than one (1) turn under the condition of the formula (1), the pulley 52 can be stably rotated with a constant speed without the wire 6 contacting itself on the pulley 52. Because of this operation, the rotary encoder 51 connected to the rotational axis detects the rotational speed and the detected results are outputted to the speed control section 100.

The rotational speed detected by the rotary encoder 51 is compared with a set speed signal obtained from the set speed, which has been set in advance in the difference circuit 101, and a motor drive circuit 102 controls the drive of the linear motor 7 corresponding to the results.

As described above, by always detecting the rotational speed of the rotary encoder unit 5 and controlling the moving speed of the linear motor 7 based on the detected signal, the moving speed of the photostimulable phosphor plate P can be controlled constant. Thus, the radiation energy stored in the photostimulable phosphor plate P can be evenly excited and a superior image can be obtained without image irregularity.

When the reading process has completed to one end of the photostimulable phosphor plate P by the optical unit 1, the linear motor 7 is stopped. After that, a deletion apparatus (not shown) irradiates the photostimulable phosphor plate P with the delete light to delete the X-ray image remaining on the photostimulable phosphor plate P. Then, further, the conveyance device conveys the photostimulable phosphor plate P to the outside of the image reading apparatus.

In the second embodiment of the present invention, in case when the apparatus has not been operated for a long time, in order to remove a curly shape of the wire 6, it is preferable that a moving operation is conducted before starting a reading operation.

According to the second embodiment of the image reading apparatus of the present invention, since the wire 6 is wound around the rotational axis of the pulley 52 with a slant state not less than one (1) turn so that the wire is inclined with a predetermined angle θ against a line A crossing the rotational axis of the pulley 52 at right angle, the abrasion of wires themselves do not occur and the load fluctuation to the pulley 52 can be suppressed. Accordingly, the pulley 52 can rotate with a constant rotational speed. As a result, the constant speed characteristic can be improved by moving the photostimulable phosphor plate P with a constant speed. Further, in case when scanning the photostimulable phosphor plate P by excitation light, a superior image without irregularity can be obtained.

Further, since the abrasion of the wires 6 themselves do not occur, the durability of the wire 6 itself can be improved.

The present invention is not limited to the above embodiment and various changes may be made without departing from the scope of the invention.

For example, the cross sectional view of guide rail 31 has been a bar shaped member having a substantially rectangular shape in this embodiment. However, the cross sectional view of guide rail 31 may be a substantially circle shape.

Further, in this embodiment, the wire 6 is wound around the pulley 52 only 1 (one) turn. However, the wire 6 may be wound around the pulley 52 a plurality of turns. In this case, it is preferable that the height of both ends of wire 6, which are fixed onto the fixing members 91a and 91b, is further changed.

Further, with respect to the material of the wire 6 used in this embodiment, for example, steel wire is listed. However, it is not limited to steel wire.

Next, the third and the fourth embodiments will be described by referring to drawings.

An object of the third and the fourth embodiments is to provide the deployment position of a shaft magnet of the shaft type linear motor, which is capable of obtaining a high quality image by reducing image irregularity and to provide image reading apparatus and an image forming apparatus, which are capable of high quality image even when adopting one guide member structure for guiding conveyance body, which is reciprocally conveyed straight on the horizontal surface.

More specifically, followings are image reading apparatus of the embodiments.

(1) An image reading apparatus for reading an image from a recording medium, onto which the image has been recorded, the image reading apparatus includes,

a guide member for guiding a conveyance body of either the recording medium, onto which the image has been recorded, or a reading section for reading the image recorded on the recording medium, so as to convey the conveyance body on the straight line

a guided member for conveying the conveyance body along the guide member while being guided by the guide member,

a shaft type linear motor for conveying the conveyance body, the shaft type linear motor being disposed in parallel with the guide member,

wherein in case when a mass of the conveyance body is “m” and an inertia moment in a yawing direction caused by rotation of the conveyance body in a horizontal direction is “I”, the shaft type magnet of the shaft type linear motor is disposed at a horizontal direction distance Xz from the guide member, so that Xz≦3√(I/m).

(2) The image reading apparatus,

wherein when a magnetic flux density of a magnetic polar position surface of the shaft type magnet is φ, and a cylindrical radius of the shaft type magnet is “r”, the shaft type magnet is disposed at a distance X from the guide member, so that X≧r×{(φ/30)̂(1/exp(1))−1}.

(3) The image reading apparatus,

wherein in the case of that the recording medium is a photostimulable phosphor sheet, and the reading section includes a photomultiplier by irradiating the photostimulable phosphor sheet with excitation light for conversing photostimulable luminance light emitted from the photostimulable phosphor sheet for photoelectric conversion, and magnetic flux density of a magnetic pole location surface of the shaft type magnet is φ and a cylindrical radius of the shaft type magnet is “r”, the shaft type magnet is disposed at a distance Xp from the photomultiplier, so that Xp≧r×{(φ/20)̂(1/exp(1))−1}.

(4) The image reading apparatus, further including,

a converting device for converting a straight line movement of the conveyance body into a rotational movement as a position detecting device for detecting a position of the conveyance body, and

a rotation detecting device for detecting a rotational position of the rotational movement,

wherein in case when the converting device is formed by wire rope and a pulley, and a magnetic flux density of a magnetic polar position surface of the shaft type magnet is φ, and a cylindrical radius of the shaft type magnet is “r”, the shaft type magnet of the shaft type linear motor is disposed at a distance Xw from the wire rope, so that Xw≧r×{(φ/30)̂(1/exp(1))−1}.

Followings are image forming apparatuses of the embodiments.

(5) An image forming apparatus for recording an image on to a predetermined recording medium including,

a guide member for guiding a conveyance body of either the recording medium or a recording section for recording the image onto the recording medium so as to convey the conveyance body on the straight line,

a guided member for conveying the conveyance body along the guide member while being guided by guide member,

a shaft type linear motor for conveying the conveyance body, the shaft type linear motor being disposed in parallel with the guide member,

wherein in case when a mass of the conveyance body is “m” and an inertia moment in a yawing direction caused by rotation in a horizontal direction of the conveyance body is “I”, the shaft type magnet of the shaft type linear motor is disposed at a horizontal direction distance Xz from the guide member, so that Xz≦3√(I/m).

(6) The image forming apparatus,

wherein a magnetic flux density of a magnetic polar position surface of the shaft type magnet is φ, and a cylindrical radius of the shaft type magnet is “r”, the shaft type magnet is disposed at a distance X from the guide member, so that X≧r×{(φ/30)̂(1/exp(1))−1}.

(7) The image forming apparatus, further including,

a converting device for converting a straight line movement of the conveyance body into a rotational movement as a position detecting device for detecting a position of the conveyance body, and

a rotation detecting device for detecting a rotational position of the rotational movement,

wherein the converting device is formed by wire rope and a pulley, and in the case when a magnetic flux density of a magnetic polar position surface of the shaft type magnet is φ, and a cylindrical radius of the shaft type magnet is “r”, the shaft type magnet of the shaft type linear motor is disposed at a distance Xw from the wire rope, so that Xw≧r×{(φ/30)̂(1/exp(1))−1}.

Thus, according to items (1) and (5), the rotational movement in a yawing direction applied to the conveyance body can be reduced to the level where the image irregularity is not a problem (or cannot be recognized).

According to the item (2) and (6), the image irregularity by the conveyance irregularity caused by the thrust fluctuation occurred between the shaft type magnet and the guide member can be reduced to the level where the image irregularity is not a problem (or cannot be recognized).

According to the item (3), the image irregularity due to the electric signal fluctuation from the change of amplification factor caused because electron amplified by the photomultiplier is trapped by the magnetic flux due to the position change of the magnetic flux density of the shaft type magnet can be reduced to the level where the image irregularity is not a problem (or cannot be recognized) and a high quality image can be obtained.

According to items (4) and (7), because of the position change of magnetic flux density of the shaft type magnet, the image irregularity caused by the position error of a length-measurement section, which is caused by the shift of winding position on the pulley of the wire rope structured by a ferromagnetic material having a characteristic of absorption to the magnet, can be reduced to the level where the image irregularity is not a problem (or cannot be recognized) and a high quality image can be obtained.

In this embodiment, since the single body of the photostimulable phosphor sheet has no rigidity and handling of the photostimulable phosphor sheet in the apparatus is difficult, it is rare to handle the single body of photostimulable phosphor sheet. In many cases, the photostimulable phosphor sheet is adhered onto a support body, such as a metal plate or a resin plate, or stored into the case named cassette, which can be freely loaded and unloaded. The photostimulable phosphor sheet is adhered onto inner surface of the cassette to be supported. As described above, the structure for supporting the photostimulable phosphor sheet on the support body or the cassette will be named a photostimulable phosphor plate in the description below. This photostimulable phosphor plate is supported on the side of the support body by being fixed onto the fixing plate with a rubber magnet.

This photostimulable phosphor plate absorbs the radiation passed through the subject when radiographing, and a part of the energy is stored as radiation image information of the photostimulable phosphor body. An image reading apparatus pertaining to this embodiment is an apparatus for reading radiation image information stored in a photostimulable phosphor body as described above.

### Third Embodiment

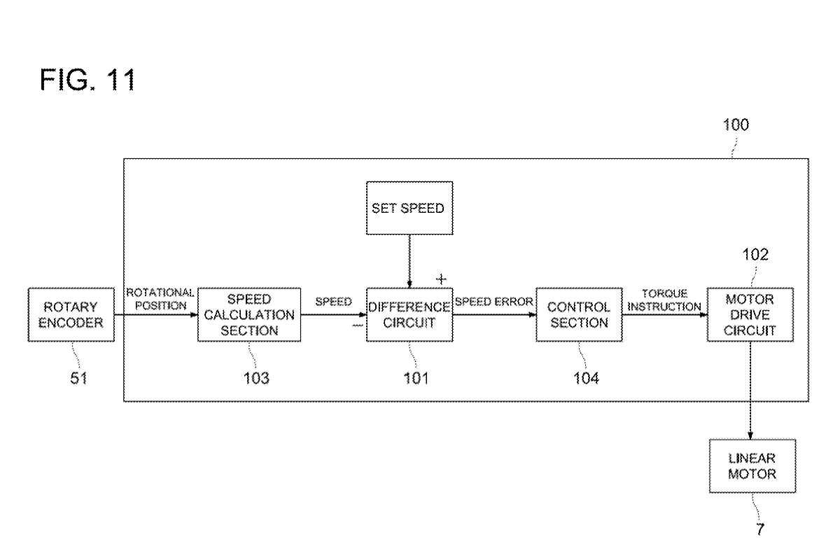

FIG. 1 illustrates a perspective view of a conveyance mechanism of an image reading apparatus of the third embodiment. FIG. 2 illustrates an X-Z plane view of FIG. 1. FIG. 3 illustrates an X-Y plane view of FIG. 1. FIG. 4 illustrates a Y-Z plane view of FIG. 1. FIG. 11 illustrates a block diagram showing a feedback control section of the image reading apparatus.

As illustrated in FIG. 1-FIG. 11, an image reading apparatus including

an optical unit (a reading section) 1 for reading the image information by irradiating with laser beam from a laser beam irradiating apparatus (not shown) to a photostimulable phosphor plate (recording medium) P while scanning and converging photostimulable luminescence light emitted from the photostimulable phosphor plate P for photoelectric conversion, and

a linear motor (a conveyance device) 7 for moving the optical unit (a conveyance body) 1, with a guide rail 31 for guiding the optical unit 1 in a horizontal direction being supported (fixed) by the support member 2 provided on the base table 4.

The image reading apparatus further includes the rotary encoder unit 5, which is connected with a traveling board 33 fixed on the optical unit 1, the rotary encoder unit 5 being a position detection device moving with the optical unit 1. The rotary encoder unit 5 includes a converting device structured by the pulley (a rotating body) 52 for converting a straight movement of the traveling board 33 into rotational movement and wire rope 6 wound around the pulley 52, and a rotary encoder 51 (a rotation detecting device) for detecting a rotational position of rotational movement.

The wire 6 is wound around the pulley 52 not less than 1 (one) turn and fixed by the fixing members 91, which will be described later. The rotary encoder unit 5 is structured so that the pulley 52, around which the wire 6 has been wound, rotates as the rotary encoder unit 5 moves along the optical unit 1. The moving speed can be obtained by detecting the rotational moving amount (position) by the rotary encoder unit 51, which detects the rotational position of the pulley 52, and differentiating the rotational moving amount with respect to the time. Further, the image reading apparatus includes a feedback control section 100 for comparing the detected moving speed and a set speed (a target speed) set in advance and controlling the linear motor 7 by a feedback control.

Respective structural members will be described in detail hereinafter.

The base table 4 has a substantially rectangular shape. The photostimulable phosphor plate P is held onto the base table 4 so that the laser irradiated surface of the photostimulable phosphor plate P is substantially vertical to the upper surface of the base table 4 by attaching the fixing plate 8 for supporting the photostimulable phosphor plate P onto the base table 4.

Further, the optical unit 1 is disposed opposed to this photostimulable phosphor plate P. The traveling board (conveyance body) 33 attached to the lower surface of the optical unit 1 is arranged so as to be capable of moving against the base table 4. Based on this arrangement, the optical unit 1 can move against the base table 4.

A longitudinal support member 2 having a plate shape extending to the horizontal direction is fixed on the substantially center of the upper surface of the base table 4 so as to be substantially horizontal. On the upper surface of the support member 2, the guide rail (a guide member) 31 for guiding the optical unit 1 in the horizontal direction is provided.

The guide rail 31 is a bar shaped member having a substantially rectangular shape in a cross sectional view. As illustrated in FIG. 4, a guided member 32, which has a substantially U-shape in the cross sectional view and is guided by the guide rail 31, is engaged with the guide rail 31. The guided member 32 is attached to the substantially center of the lower surface of the traveling board 33.

The optical unit 1 is supported so as to be freely moved by the support member 2, the guide rail 31, the guided member 32 and the traveling board 33 on the base table 4. The optical unit 1 is disposed opposed to the photostimulable phosphor plate P.

Further, on the upper surface of the base table 4, a linear motor holding section 72 for holding the magnet section (a shaft type magnet) 71 structuring the linear motor 7 is provided on the side direction of the support member 2 (the side direction of the guided member 32 provided at the substantially center of the traveling board 31). The magnet section 71 is formed into a shaft shape by plural magnets having a circular shape in a cross sectional view connected so that the N-poles of permanent magnets or S-poles of the permanents magnet are regularly opposed to each other.

A moving coil 73 structuring a linear motor 7 is provided in a magnet section 71. The moving coil 73 has a coil structured in a cylindrical shape and the coil is covered by a covering member having a box style. The moving coil 73 is provided on the lower surface of the traveling board 33. The linear motor 7 is structured so that the magnet section 71 passes through the center of the moving coil 73.

Further, the holding member 9 having a longitudinal plate shape extending in a horizontal direction parallel with the support member 2 is fixed so as to be in substantially horizontal in the side direction of the linear motor holding section 72 on the upper surface of the base table 4. As illustrated in FIG. 1, the fixing members 91a and 91b having substantially L character type in a cross sectional view are provided in the longitudinal direction at both ends of the upper surface of the holding member 9. The both ends of wire 6 are fixed onto these fixing members 91a and 91b so as to become different in terms of height. The rotary encoder unit 5 is connected to the wire 6.

The rotary encoder unit 5 includes a support table 53, which is capable of moving together with the traveling board 33, onto which the support table 53 has been fixed, the rotary encoder 51, which is provided on the support table 53 and the pulley 52, which is jointed to a rotational shaft (not shown) of the rotary encoder 51 and attached to the lower surface of the support table 53. As described above, the pulley 52 is attached to the rotary shaft of the rotary encoder 51.

With respect to the material of the pulley 52, a soft magnetic material such as aluminum material, which is not attracted or hard to be attracted by a magnet is preferable. With respect to the material of the wire 6, for example, stainless steel coated with resin, such as nylon, is preferable. With respect to the material of the pulley 52, the surface hardness of the material is not less than the surface hardness of wire rope 6 is preferable. Alumite treatment is preferably applied, or duralumin or stainless steel is preferably used for the material of the pulley 52. As described above, by setting the surface hardness of the pulley 52 equal to or more than the surface hardness of the wire rope 6, the abrasion of the pulley 52 can be suppressed. Further, the durability of the pulley 52 itself can be improved and, at the same time, the deterioration of the constant speed rotation due to the abrasion can also be suppressed.

As described above, the rotational speed information is obtained as follows.

The wire rope 6 wound around the pulley 52 is constructed so that pulley 52 rotates because the rotary encoder 51 is arranged to move together with the movement of the optical unit 1 and the traveling board 33. The rotary encoder 51 detects the rotational position of the pulley 52. Then, the detected rotational speed information is outputted to the feedback control section 100 for controlling the rotational speed of the linear motor 7.

As illustrated in FIG. 11, the feedback control section 100 includes a speed calculation section 103, a difference circuit 101, a control section 104 and a motor drive circuit 102.

The speed calculation section 103 converts the rotational position, which is inputted from the rotary encoder 51 to position signal and calculates the speed of the conveyance body (the optical unit 1 and the traveling board 33) by differentiating the position signal with respect to time. The difference circuit 101 generates a speed error signal by outputting the difference of the calculated speed and the set speed set in advance.

The control section 104, for example, executes PID control calculation to generate torque instruction signal based on speed control signal. The motor drive circuit 102 supplies driving power to the linear motor 7 in response to the torque instruction signal and the position of the conveyance body.

The example of speed feedback control has been shown. However, instead of speed, position feedback control for feeding back the position may be feasible. With respect to the control section 104, an example of PID control has been described. The feedback control can be configured by a modern controller, such as, of H-infinity control. The feedback control is not limited to this embodiment.

On the other hand, the optical unit 1 includes

a laser irradiating apparatus for irradiating the photostimulable phosphor plate P with laser beam L1 while scanning in the direction perpendicular to the moving direction of the photostimulable phosphor plate P,

a light guide plate 13 for guiding photostimulable luminescence light L2 excited by the irradiation of laser beam L1 onto the photostimulable phosphor plate P by the laser irradiating apparatus,

a light collecting tube 11 for collecting the photostimulable luminescence light L2 guided by the light guide plate 13, and

a photoelectric converter (photomultiplier) 12 for converting the photostimulable luminescence light L2, which is collected by the light collecting tube 11, to electric signals.

Here, the image reading apparatus of the present invention includes a deletion apparatus (not shown) for irradiating the photostimulable phosphor plate P with deletion light in order to release radiation energy remaining in the photostimulable phosphor plate P after having completed the reading operation of the radiation energy by the optical unit 1.

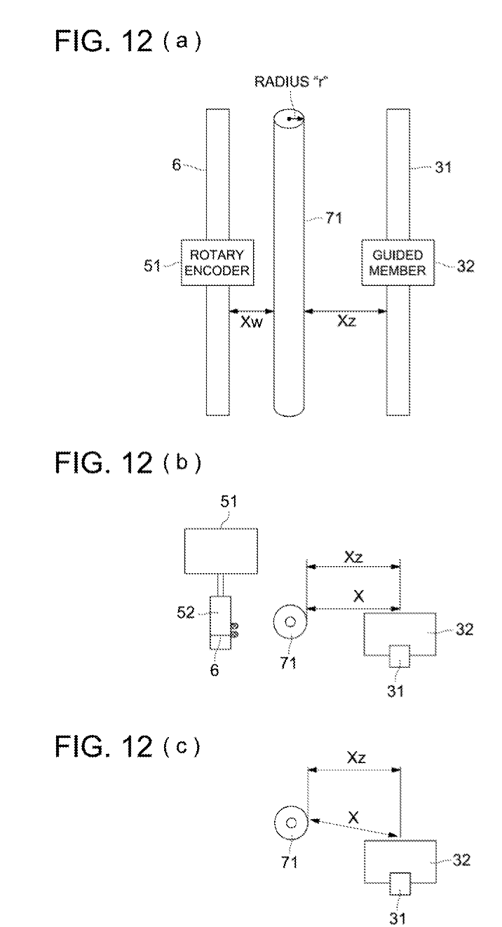

Next, the position relationship of the guide rail 31, the guided member 32, the linear motor 7, the magnet section 71, the wire rope 6 and the rotary encoder 51 will be described by referring to FIG. 12.

FIG. 12(a) schematically illustrates a position relationship of the respective structural members described above with respect to FIG. 2. FIG. 12(b) schematically illustrates the position relationship with respect to FIG. 4. FIG. 12(c) illustrates a case where the heights of the magnet section 71 and the guide rail 31 are different from each other.

When assuming that “m” as the mass of the optical unit 1 and the traveling board 33, each of which is a conveyance body that moves on the guide rail 31, and assuming that “I” is the inertial moment in the yawing direction of the optical unit 1 and the traveling board 33 rotating in a horizontal direction, the magnet section 71 is disposed so that the distance Xz from the guide rail 31 is not more than 3√(I/m). This formula has been obtained as follows. The ratio of the acceleration in the conveyance direction and the acceleration in the rotational direction at the level where the image irregularity can be reduced to the level where the image irregularity is not a problem (or not be recognized) is obtained by conducting experiment. Then the experimental result is assigned to the formula derived from formulas; αs=F/m and, ωr=(αr/Xz)=F·Xz/I, where “αs” is an acceleration in the conveyance direction and “ωr” is an angular velocity in the rotational direction.

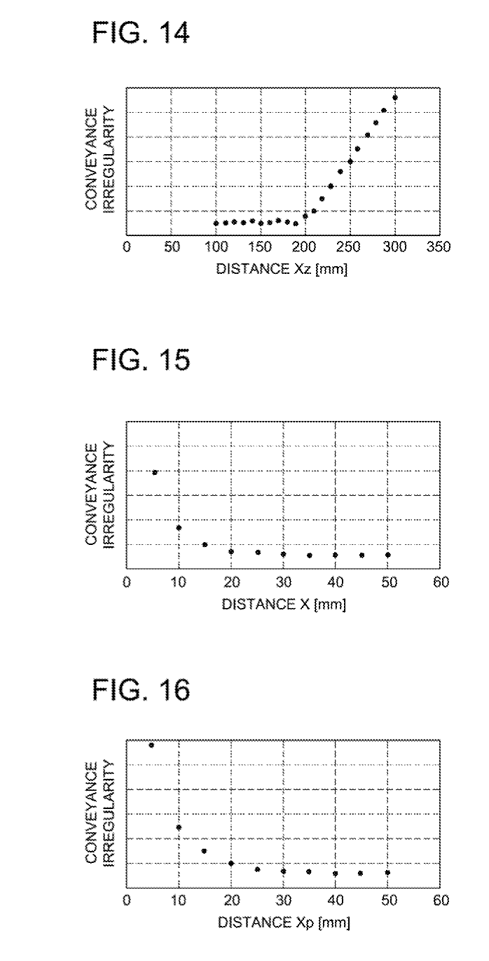

Here, F denotes a motor thrust and αr denotes a normalized position rotational acceleration. More specifically, in case when the conveyance body whose mass is 10 kg and inertial moment is 0.043 kg·m² is structured, the distance Xz is preferably set not more than 0.2 m. This fact is clear from the experimental results illustrated in FIG. 14. FIG. 14 illustrates a graph showing a horizontal direction distance Xz between the guide rail 31 and the magnet section 71 in the lateral axis and the amplitude of conveyance irregularity in a vertical axis. The conveyance irregularity denotes the maximum amplitude of the speed fluctuation compared with a constant speed when conveying the conveyance body at an image reading operation.

According to the arrangement described above, the image irregularity can be reduced to the level where the image irregularity is not a problem (or cannot be recognized) with the image irregularity being caused because the conveyance body configured by the traveling board 31 and the optical unit 1 is rotated and displaced by the force in the yawing direction, which is added to the conveyance body. Thus, a superior image can be obtained.

Assuming that the magnetic flux density on the magnet pole position surface of the magnet section 71 is “φ”, and the cylindrical radius of the magnet section 71 is “r”, the magnet section 71 is disposed so that the distance X satisfies; X≧r×{(φ/30)̂(1/exp(1))−1}. Here, the obtained formula is derived from relationship between the formula φX=φ{r/(r+X)}̂exp(1), which is obtained for approximation of the measured result of the magnetic flux density at distance X from the magnetic pole position surface of the real shaft type magnet, and the distance relationship obtained from the conveyance irregularity (image irregularity), which has been actually measured when disposing the shaft type magnet at the distance X from the guide rail 31 and the guided member 32. More specifically, assuming that the radius is 10 mm and the magnetic flux density at the magnet pole position surface is 600 mT, the distance X corresponds to not less than 20 mm. This fact is clear from the actual measurement result in FIG. 15. FIG. 15 illustrates a graph showing a distance X, which is a distance between the guide rail 31 and a magnet section 71 in the lateral axis and the amplitude of conveyance irregularity in a vertical axis.

Even though the guide rail 31 and the guided member 32 are structured by ferromagnetic material, which is attracted by a magnet, the image irregularity from the conveyance irregularity caused by the thrust fluctuation generated between the magnet section 71 and the guide rail 31 can be reduced to the level where the image irregularity becomes no problem (or cannot be recognized). Thus, a high quality image can be obtained. Here the magnetic pole position is defined as a position where the magnetic flux density of the cylindrical surface of the magnet section 71 is the highest when two N-poles or two S-poles are respectively disposed so as to be opposed to each other.

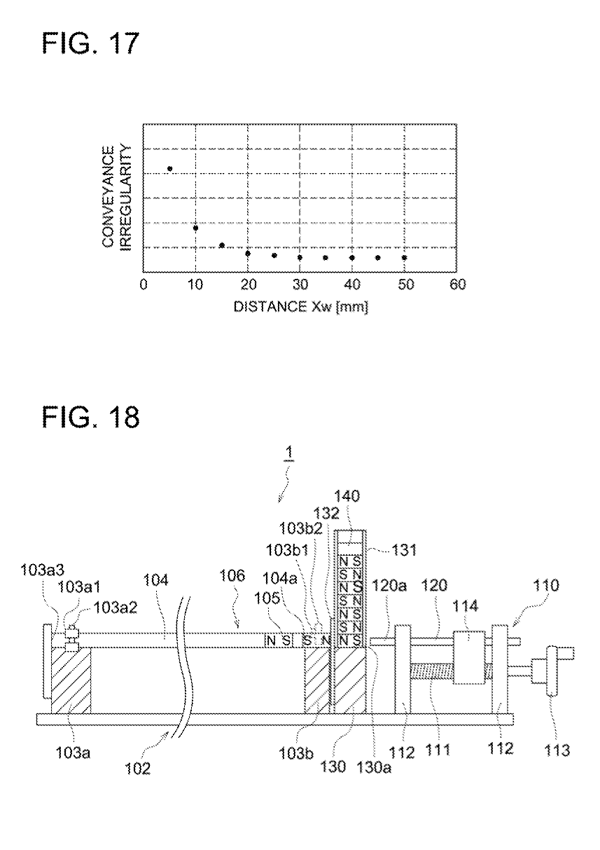

Further, the magnet section 71 is disposed at the distance Xw from the wire rope 6 satisfies, Xw≧r×{(φ/30)̂(1/exp(1))−1}. More specifically, assuming that the radius is 10 mm and the magnetic flux density of magnetic pole position surface is 600 mT, the distance X corresponds to approximately not less than 20 mm. This fact is clear from the actual measurement results in FIG. 17. FIG. 17 illustrates a graph showing distance Xw, which is a distance between the wire rope 6 and the magnet section 71, in the lateral axis and the amplitude of conveyance irregularity in a vertical axis.

Based on this arrangement, the image irregularity due to the positional error of the length measurement section caused by the winding position displacement of the wire 6 wound around the pulley 52 formed by ferromagnetic material can be reduced to the level where the image irregularity is not a problem (or cannot be recognized). Thus, a high quality image can be obtained.

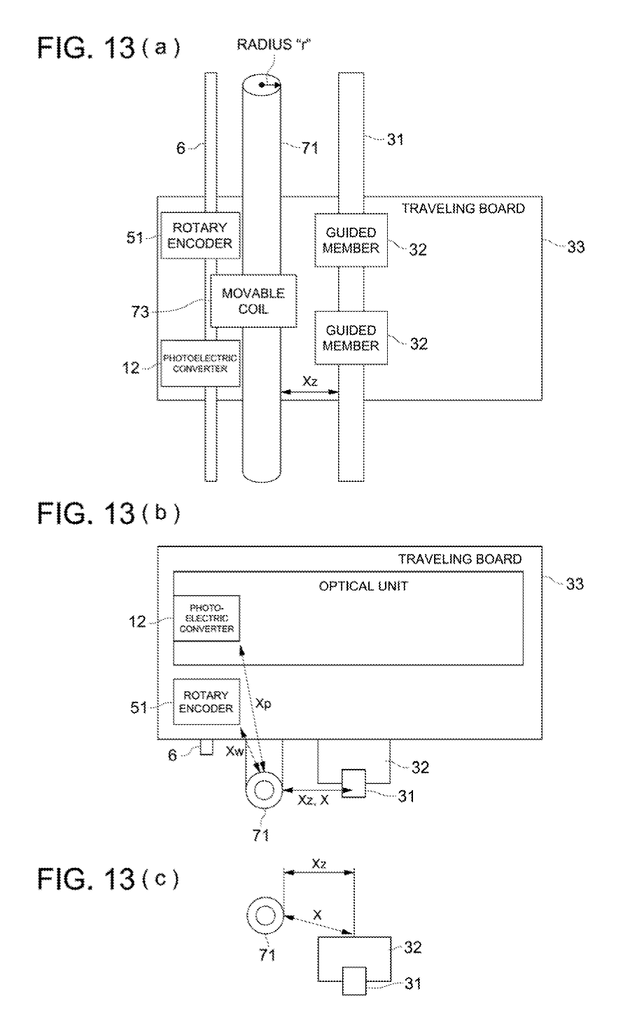

FIG. 13 schematically illustrates the position relationship between the guide rail 31, the guided member 32, the magnet section 71, the wire rope 6, the rotary encoder 51 and the photoelectric converter 12 in case when the optical unit 1 is attached on the traveling board 33 so as to be parallel with the traveling board 33. FIG. 13(a) illustrates the X-Z plane view, FIG. 13(b) illustrates the Y-Z plane view and FIG. 13(c) illustrates a case where the heights of magnet section 71 and the guide rail 31 are different from each other.

In the case of FIG. 13, it is preferable that the magnet section 71 is disposed so that the distance Xp from the photoelectric converter 12 of the optical unit 1 satisfies; Xp≧r×{(φ/20)̂(1/exp (1))−1}. More specifically, assuming that the radius is 10 mm and the magnetic flux density of magnetic pole position surface is 600 mT, the distance Xp corresponds to approximately not less than 25 mm. This fact is clear from the actual measurement results in FIG. 16. FIG. 16 illustrates a graph showing the distance Xp, which is a distance between the photoelectric converter 12 and the magnet section 71 in the lateral axis and the amplitude of conveyance irregularity in a vertical axis.

By disposing the traveling board 33 based on this arrangement, the image irregularity by the electric signal fluctuation caused by the amplification factor change generated by that electrons amplified by the photoelectric converter 12 are trapped by magnetic flux due to the position change of the magnetic flux density change of the magnet section 71 can be reduced to the level where the image irregularity is not a problem (or cannot be recognized). Thus, a high quality image can be obtained.

Here, it is assumed that the photostimulable phosphor plate P is disposed above the optical unit 1 and opposed to the optical unit 1, even though it is not shown in FIG. 13.

Next, operation of the image reading apparatus having the configuration described above will be described.

The photostimulable phosphor plate P is taken to inside the image reading apparatus by the conveyance device and fixed onto the fixing plate 8. When conducting a reading process of an image, the linear motor 7 is driven to move the traveling board 33, which supports the optical unit 1, along the guide rail 31 in the horizontal direction.

Based on this operation, the optical unit 1 is moved so as to be opposed to the laser irradiated surface of the photostimulable phosphor plate P. The laser irradiation apparatus irradiates the photostimulable phosphor plate P with a laser beam while moving the optical unit 1 in the horizontal direction on the photostimulable phosphor plate P. At this moment, the photostimulable phosphor plate P is irradiated with the laser beam while scanning in the direction perpendicular to the moving direction of the optical unit 1. As the result, excited photostimulable luminescence light is guided by the light guide plate 13, collected by the light collecting tube 11 and converted into the electric signal by the photoelectric converter 12.

As described above, since as the optical unit 1 and the traveling board 33 move in the horizontal direction, the rotary encoder 51 of the rotary encoder unit 5 provided on the traveling board 33 moves together with the optical unit 1 and traveling board 33, the pulley 52 and rotational shaft rotate. Based on this operation, the rotary encoder 51 detects the rotational position of the pulley 52 and outputs the detected rotation speed information to the feedback control section 100 of the linear motor 7.

The rotation speed information detected by the rotary encoder 51 is compared with the set speed signal obtained from the set speed set in advance at the difference circuit 101. The motor drive circuit 102 controls the drive of the linear motor 7 in response to the result.

With respect to the driving method of the linear motor 7, a known driving method is used. For example, by changing the frequency and voltage of the alternate drive current by the inverter control, the moving speed of the linear motor 7 can be controlled. Further, the moving speed of the linear motor 7 may be controlled by the pulse width of the pulse voltage to be inputted to the moving coil 73 of the linear motor 7 based on a PWM control.

As described above, the moving speed of the optical unit 1 can be controlled constant by always detecting the rotational speed of the rotary encoder 51 and controlling the moving speed of the linear motor 7 based on the detection result. Thus, by exciting the radiation energy at a constant distance, which is stored in the photostimulable phosphor plate P, a superior image having extremely low image irregularity in the conveyance direction (moving direction) can be obtained.

When the reading process by the optical unit 1 to the edge portion of the photostimulable phosphor plate P has completed, the linear motor 7 will be stopped.

After that, a deletion apparatus (not shown) irradiates the photostimulable phosphor plate P with the deletion light to delete the radiation image remaining on the photostimulable phosphor plate P. Then further, another plate conveyance device (not shown) will convey the photostimulable phosphor plate P to outside the reading apparatus.

### Fourth Embodiment

FIG. 7 illustrates a perspective view of the conveyance mechanism of the image reading apparatus of the fourth embodiment of the present invention. FIG. 8 illustrates an X-Z plane view in FIG. 7. FIG. 9 illustrates an X-Y plane view in FIG. 7. FIG. 10 illustrates a Y-Z plane view in FIG. 7.

In the image reading apparatus of the fourth embodiment, which is different from the third embodiment, the optical unit 1 has been fixed onto the base table 4 and the photostimulable phosphor plate P (a conveyance body) is arranged to move in the horizontal direction.

In other words, as illustrated in FIGS. 7-10, the optical unit 1 is disposed so as to oppose to the upper surface of the base table 4. The photostimulable phosphor plate P is disposed between the base table 4 and optical unit 1. The fixing plate 8 is attached on the lower surface of the photostimulable phosphor plate P and the fixing plate 8 is attached to the traveling board (a conveyance body) 33, which is capable of moving with respect to the base table 4. Thus, the photostimulable phosphor plate P is capable of moving with respect to the base table 4.

The same symbols will be given to the structural portion to be described below, which is the same as the third embodiment.

The base support member 2 is provided at the substantially center of the upper surface of the base table 4 and the guide rail 31 is provided on the support member 2. Further the guided member 32 is engaged with the guide rail 31. The guided member 32 is attached on the substantially center of the lower surface of the traveling board 33.

As described above, the photostimulable phosphor plate P is supported by the support member 2, the guide rail 31, the guided member 32 and the traveling board 33 on the base table 4. The photostimulable phosphor plate P is disposed so as to oppose to the optical unit 1.

The same as the third embodiment, there are provided the linear motor 7, the linear motor support section 72, the magnet section 71 and the moving coil 73 on the upper surface of the base table 4. Further, there are provided the support member 9, the fixing members 91a and 91b on the upper surface of the base table 4. Further, the both ends of the wire rope 6 are fixed by the fixing members 91a and 91b so that the heights of both ends are different from each other. The wire rope 6 is wound and linked around the pulley 52 of the rotary encoder unit 5 not less than 1 (one) turn.

The rotary encoder unit 5 includes the support table 53, the rotary encoder 51 and the pulley 52, which are fixed onto the traveling board 33 and capable of moving, as the same as the third embodiment.

The fourth embodiment includes the same feedback control section 100 as the third embodiment. Further, the optical unit 1 has the same function as the third embodiment.

Further, the positional relationship of the guide rail 31, the magnet section 71 of the linear motor 7, the guided member 32, the wire rope 6 and the rotary encoder 51 is the same as the third embodiment.

That is, in the same as FIG. 12, the horizontal direction distance Xz between the magnet section 71 and the guide rail 31 preferably satisfies the following formula.

Xz≦3√(I/m)

Further, with respect to the relationship with the magnetic flux density φ, the distance X preferably satisfies; X≧r×({φ/30)̂(1/exp (1))−1}.

Further the distance Xw between the magnet section 71 and the wire rope 6 preferably satisfies; Xw≧r×{{+/30}̂(1/exp (1))−1}.

Since in the fourth embodiment, the optical unit 1 is fixed and does not move and the trapped amount of the electrons amplified by the photoelectric converter 12 of the optical unit 1 does not change, fluctuation does not appear as image irregularity. Thus, it is not necessary to provide limitation on the distance Xp as provided in the third embodiment. However, since the approach of the photoelectric converter 12 to the magnet section 71 lowers the amplification factor, it is preferable to dispose the photoelectric converter 12 not less than Xp from the magnet section 71.

Next, operation of the image reading apparatus having the configuration described above will be described.

The photostimulable phosphor plate P is taken to inside the image reading apparatus by the conveyance device and fixed onto the fixing plate 8. When conducting a reading process of an image, the linear motor 7 is driven to move the traveling board 33 supporting photostimulable phosphor plate P along the guide rail 31 in the horizontal direction.

Based on this operation, the photostimulable phosphor plate P is moved to the place where the photostimulable phosphor palate P opposes to the laser irradiation surface of the optical unit 1. The laser irradiation apparatus scans the photostimulable phosphor plate P by laser beam while moving photostimulable phosphor plate P in the horizontal direction of the optical unit 1. At this moment, the photostimulable phosphor plate P is irradiated with the laser beam while scanning the photostimulable phosphor plate P in the direction perpendicular to the moving direction of the optical unit 1. As the result, excited photostimulable luminescence light is guided by the light guide plate 13, collected by the light collecting tube 11 and converted into the electric signal by the photoelectric converter 12.

As described above, because the photostimulable phosphor plate P and the traveling board 33 move in the horizontal direction, the rotary encoder 51 of the rotary encoder unit 5 provided on the traveling board 33 move together with the traveling board 33. Accordingly, the pulley 52 and the rotational shaft rotate. Based on this operation, the rotary encoder 51 detects the rotation position of the pulley 52 and outputs the detected rotation speed information to the feedback control section 100 of the linear motor 7.

The rotation speed detected by the rotary encoder 51 is compared with a set speed signal obtained from the set speed set in advance at the difference circuit 101. The motor drive circuit 102 controls the drive of the linear motor 7 in response to the result.

As described above, the moving speed of the photostimulable phosphor plate P can be controlled by always detecting the rotational speed of the rotary encoder 51 and controlling the moving speed of the linear motor 7 based on the detection result. Thus, by exciting the radiation energy at the constant interval, which is stored in the photostimulable phosphor plate P, a superior image having extremely low image irregularity in the conveyance direction (moving direction) can be obtained.

When the reading process by the optical unit 1 to the one end portion of the photostimulable phosphor plate P has completed, the linear motor is stopped. After that, a deletion apparatus (not shown) irradiates the photostimulable phosphor plate P with the deletion light to delete the radiation image remaining on the photostimulable phosphor plate P. Then further, another plate conveyance device (not shown) conveys the photostimulable phosphor plate P to outside the reading apparatus.

The present invention is not limited to the above embodiment and various changes and modification may be made without departing from the scope of the invention.

For example, the guided member may be one. However, a plurality of guided members or particularly two guided members are preferable. Because the optical unit 1 and the photostimulable phosphor plate P can be stably conveyed.

Further, since the rotary encoder 51 is also an electric part, the rotary encoder 51 is preferably disposed at the distance from the magnet 71 not less than the distance Xw.

Further, in the embodiment described above, an image reading apparatus for reading image by irradiating laser beam has been exampled to described the reading operation of the information of radiation image stored in the photostimulable phosphor plate P. However, instead of the photostimulable phosphor plate P, it may be applied to an image forming apparatus for forming an image onto the photosensitive material (a recording medium (a recording object)) by irradiating the photosensitive material with laser beam.

Further, it may be applied to the image forming apparatus for jetting ink onto a recording medium, such as a paper sheet. Instead of scanning and irradiating with laser beam as a main scan in a vertical direction to the conveyance direction, a mechanism for conducting the main scan by winding the photostimulable phosphor plate P, a photosensitive material or paper sheet around a drum may be possible.

Next, a fifth embodiment pertaining to a manufacturing method of a shaft type linear motor and a manufacturing apparatus for the shaft type linear motor will be described. However, the present invention is not limited to this embodiment.

The fifth embodiment relates to a manufacturing method of a shaft type linear motor and a manufacturing apparatus for the shaft type linear motor, which has a simple structure and is able to simply and easily store repelling magnets.

More specifically, the shaft type linear motor manufacturing method is as follows.

(1) A method of manufacturing a shaft type linear motor by inserting a plurality of magnets into a pipe shaped member to assemble a stator so that adjacent magnets are repelled to each other, the method including the steps of,

providing a fixing table for fixing the pipe shaped member,

providing a shaft shaped member capable of moving parallel with a longitudinal direction of the pipe shaped member,

moving the magnets parallel with a longitudinal direction of the pipe shaped member by the shaft shaped member, and

storing the magnets into the pipe shaped member.

(2) The method of manufacturing a shaft type linear motor including the steps of,

moving the magnets parallel with a longitudinal direction of the pipe shaped member to a position between an opening section of the pipe shaped member and the shaft shaped member, and

conveying the magnets in the opening section of the pipe shaped member.

(3) The method of manufacturing a shaft type linear motor,

wherein the magnets to be conveyed to a position between the opening section of the pipe shaped member and the shaft shaped member are arranged so that respective side surfaces of magnetic poles of the magnets attract to each other.

(4) The method of manufacturing a shaft type linear motor including the steps of,

conveying a sealing member having the same external dimension as the magnet by the same method applied to the magnets, and

sealing the pipe shaped member after a predetermined number of magnets has been conveyed into the pipe shaped member.

The manufacturing apparatus for the shaft type linear motor is as following.

(5) A manufacturing apparatus for a shaft type linear motor for inserting a plurality of magnets into a pipe shaped member to assemble a stator so that adjacent magnets are repelled to each other, the manufacturing apparatus including,

a fixing table for fixing the pipe shaped member,

a shaft shaped member, which is capable of moving in parallel with a longitudinal direction of the pipe shaped member, and

an inserting mechanism for moving the magnets parallel with a longitudinal direction of the pipe shaped member by using the shaft shaped member and inserting the magnets into the pipe shaped member.

(6) The manufacturing apparatus for the shaft type linear motor,

wherein the inserting mechanism moves the magnets in parallel with a longitudinal direction of the pipe shaped member to a position between an opening section of the pipe shaped member and the shaft shaped member, and conveys the magnets in the opening section of the pipe shaped member.

(7) The manufacturing apparatus for the shaft type linear motor,

wherein the magnets to be conveyed to a position between the opening section of the pipe shaped member and the shaft shaped member are arranged so that respective side surfaces of magnet poles of the magnets attract to each other.

(8) The manufacturing apparatus of the shaft type linear motor including,

a device for conveying a sealing member having the same external dimension as the magnet by the same method applied to the magnets, and

a device for sealing the pipe shaped member after a predetermined number of magnets has been conveyed into the pipe shaped member.

According to items (1) and (5), it becomes possible to hold the repelling magnets by a simple structure and to simply and easily insert the magnet into the pipe shaped member by inserting the magnets by moving the magnets parallel with a longitudinal direction of the pipe shaped member by using the shaft shaped member.

According to the items (2) and (6), it becomes possible to simply and easily install the magnet into the pipe shaped member by moving the magnets in parallel with a longitudinal direction of the pipe shaped member to the position between a opening section of the pipe shaped member and the shaft shaped member. For example, it becomes possible to send the magnet to the opening section of the pipe shaped member by utilizing own weight or a spring pressure.

According to the items (3) and (7), since the magnets to be conveyed to the position between the opening section of the pipe shaped member and the shaft shaped member are arranged so that respective side surfaces of magnet poles of the magnets attract to each other, the workability becomes high and it becomes possible to simply and easily install the magnets so as to be repelling to each other by serially inserting the magnets into the pipe shaped member by using the shaft shaped member.

According to the items (4) and (8), since a sealing member having the same external dimension as the magnet is inserted by the same method applied to the magnets, and the pipe shaped member is sealed after a predetermined number of magnets has been conveyed and a simple structure can be achieved because the same mechanism as one for conveying the magnets into the pipe shaped member.

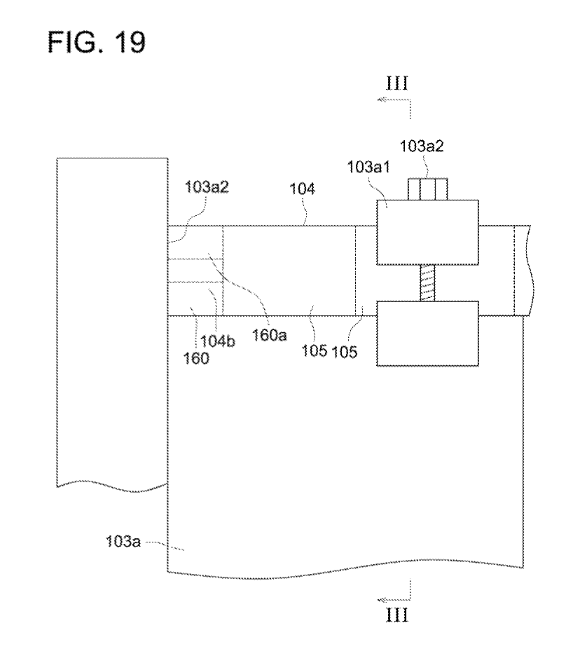

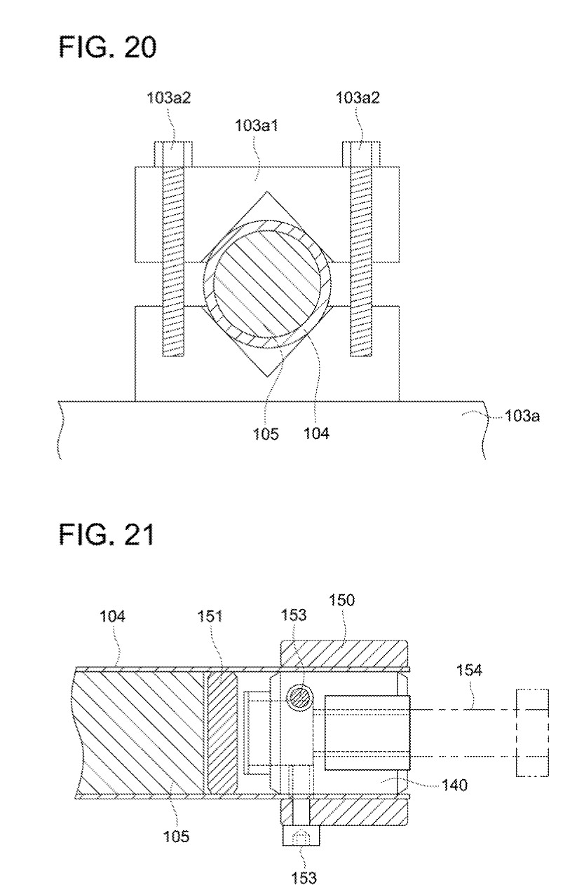

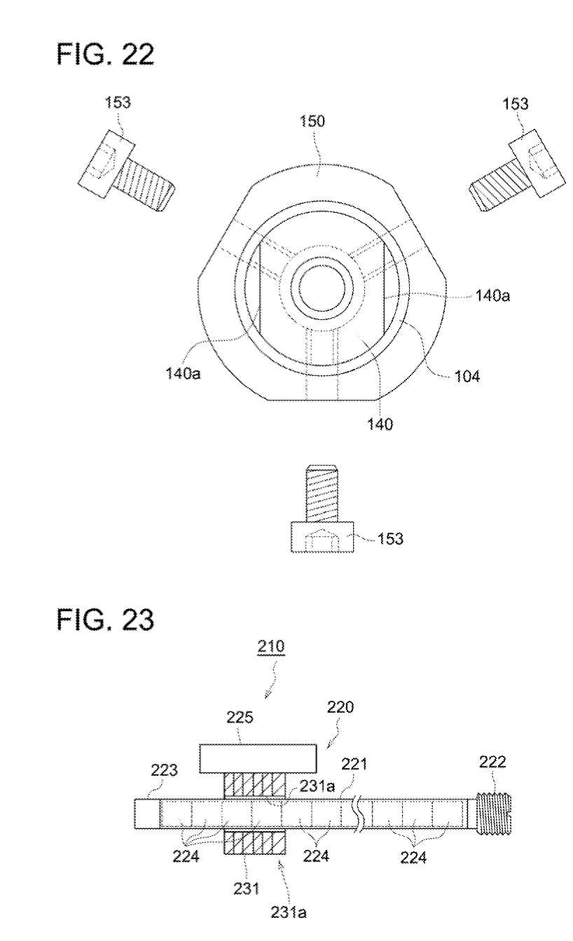

FIG. 18 illustrates a schematic diagram of a manufacturing apparatus for a shaft type linear motor. FIG. 19 illustrates a magnification view of a fixing table section. FIG. 20 illustrates a cross sectional view along the line III-III in FIG. 19. FIG. 21 illustrates a cross sectional view of a fixing section of the sealing member for a rear end section of the shaft type linear motor. FIG. 22 illustrates a front view of a fixing section of the sealing member for a rear end section of the shaft type linear motor.

The manufacturing apparatus 101 of the shaft type linear motor of this fifth embodiment includes an apparatus main body 102 provided with a pair of fixing tables 103a and 103b. On these fixing tables 103a and 103b, a pipe shaped member 104 is placed so that the longitudinal direction of the pipe shaped member 104 becomes the horizontal direction. This pipe shaped member 104 is fixed onto the fixing tables 103a and 103b by holding members 103a1 and 103b1. These holding members 103a1 and 103b1 are attached onto the fixing tables 103a and 103b by bolts 103a2 and 103b2. The holding members 103a1 and 103b1 hold the pipe shaped member 104 so that the repelling force of the magnets 105 does not drive off the pipe shaped member 104.

In FIGS. 18 and 19, the fixing table 103a positioned in the left side includes a butting surface 103a3, to which the front end section 104b of the pipe shaped member 104 has been butted. A sealing member 160 having a female screw 160a is provided at the front end section 104b of the pipe shaped member 104 and this sealing member 160 prevents the magnet 105 from being removed. The sealing member 160 has the same external dimension as the magnet 105. The butting surface 103a3 of the fixing member 103a regulates the pipe shaped member 104 not to be pushed out by the repelling force of the magnet 105 when inserting the magnet 105 into the pipe shaped member 104. A plurality of magnets 105 is installed in series into the pipe shaped member 104 so that the opposite magnet poles are faced to each other. This pipe shaped member 104 and the magnets 105 form the stator 106 of the shaft type linear motor 106.

The apparatus main body 102 includes an inserting mechanism 110. This inserting mechanism 110 includes a trapezoidal screw 111, which is supported by the support tables 112 so as to be capable of rotating. The trapezoidal screw 111 is rotated by a handle 113 clockwise and counterclockwise. A shaft shaped member 120 is supported by the pair of the support tables 112 and a connection member 114 is fixed onto the shaft shaped member 120. This connection member 114 moves on the trapezoidal screw 111 due to the rotation of the trapezoidal screw 111. The shaft shaped member 120 moves parallel with a longitudinal direction of the pipe shaped member 104 due to the movement of this connection member 114.

The receiving table 130 is disposed between the opening section 104a of the pipe shaped member 104 and the front end section 120a of the shaft shaped member 120, and a magnet storing member 131 is disposed on the receiving table 130. The magnets 105 are aligned in the magnet storing member 131 so that the magnet poles of the magnets 105 attract to each other in the side surface direction. The magnet 105 is butted against the butting surface 130a from the magnet storing member 131 to the receiving table 130 by the own weight or spring pressure. In this case, the material of the butting surface 130a is preferably structured by a material having hardness degree the same as that of the magnet 105 or less than that (for example, resin).

In the fifth embodiment, with respect to the magnet 105, a permanent magnet having a cylindrical shape or a cylindrical column type magnet is used. Further, with respect to the material of the magnet 105, a rare-earth magnet having a large magnetic flux density is preferably used. Particularly, with respect to the rare-earth magnet, neodymium system magnet, for example, a Neodymium-Iron-Boron magnet (Nd—Fe—B magnet) is preferable. Comparing with other magnets, a higher thrust can be obtained.

In the top section of the magnet 105, a sealing member 140 having the same external dimension as the magnet 105 is stored.

The opening section 104a of the pipe-shaped member 104 can be opened or closed by a shutter 132. In case when operating the handle 113 to rotate the trapezoidal screw 111 after opening the shutter 132, the shaft shaped member 120 is moved forward by the connection member 114 and the front end portion 120a pushes the magnet located at the lowest section of the magnet storing member 131. Then the magnet 105 is conveyed to the opening section 104a of the pipe shaped member 104.

The shaft shaped member 120 inserts the magnet 105 pressed on the butting surface 130a into the opening section 104a of the pipe shaped member 104. When the magnet 105 has entered the opening section 104a of the pipe shaped member 104, the shutter 132 holds the repelling magnet 105 not to be flown out of the opening section 104a.

After having conveyed this magnet 105, when rotating the trapezoidal screw 111 in a reverse direction by operating the handle 113, the shaft shaped member 120 is moved back by the connection member 114 and the front end section 102a of the shaft shaped member 120 is moved back from the lowest position of the magnet storing section 131. Based on this backup movement, the magnet 105 in the magnet storing member 131 moves parallel in the vertical direction to the longitudinal direction. Then the magnet 105 located in the lowest position is placed on the receiving table 130.

In case when operating the handle 113 again to rotate the trapezoidal screw 111, the connection member 114 moves the shaft shaped member 120 forward and the front end section 120a pushes the magnet 105 located in the lowest position of the magnet storing section 131. Thus the magnet 105 is conveyed to the opening section 104a of the pipe shaped member 104.

Based on the repetition of this operation, the shaft shaped member 120 reciprocally moves and the magnet 105 can be sequentially inserted. After a predetermined number of magnets 105 have been inserted into the pipe shaped member 104, the sealing member 140 having the same external dimension is inserted by the same method described above to seal the pipe shaped member 104.

The fixing of this sealing member 140 is conducted as illustrated in FIGS. 21 and 22. At last, a holding member for holding the repelling magnet 105 is inserted to hold the repelling magnet 105. That is, a fixing ring 150 is arranged to precisely fit the outer diameter of the pipe shaped member 104 (to the degree of lightly being inserted). Before setting the pipe shaped member 104 in the apparatus main body 102, the fixing ring 150 has been inserted by the pipe shaped member 104 in advance. At this moment, the fixing ring 150 may have been adhered to the pipe shaped member 104 or may be arranged to have been held based on the friction between parts with a degree that the fixing ring 150 can be inserted with a light friction.

After filling the magnet 105 into the pipe shaped member 104, the spacer 151 and the sealing member 140 are sequentially filled into the pipe shaped member 104. After the sealing member 140 has been inserted, three screws 53 fix the fixing ring 150 onto the sealing member 140. The surfaces 140a like a D-cut are provided with the sealing member 140 opposed to each other. The directions of the (screw) holes of respective parts can be determined by using these surfaces 140a. In this fifth embodiment, when filling the sealing member 140 into the pipe shaped member 104, the sealing member 140 is filled into the pipe shaped member 104 by butting the surfaces 140a to a guide member (which is not shown) to meet with the screw hole direction.

Next, a screw 154 is screwed into the sealing member 140 in an axis direction to inset the spacer 151 in order to eliminate the spaces generated by the repelling forces of the magnets 105. This spacer is used because there is a fear that when the screw 154 directly butts the magnet 105, the magnet might have possible damages. The fixing ring 150, the pipe shaped member 104 and the sealing member 140 are all structured by non-magnetic material, (such as brass or aluminum).

In this fifth embodiment, the detection device for detecting the polarity of the magnet is provided so that the magnetic pole of all the first magnet filled in to the pipe shaped member 104 have the same magnetic pole direction. And the magnet storing member 131 is structured so that the magnetic storing member 131 can be fixed in one orientation.

As described above, with the shaft shaped member 120, by moving the magnets 105 in parallel with the longitudinal direction of the pipe shaped member 104 and storing the magnets 105 into the pipe shaped member 104, it is possible to hold the repelling magnets 105 with a simple structure and simply and easily store the magnets 105 into the pipe shaped member 104. Further, by moving the magnet 105 to the position between the opening section 104a of the pipe shaped member 104 and the shaft shaped member 120 parallel in a vertical direction to a longitudinal direction of the pipe shaped member 104 and conveying the magnets 105 to the opening section 104a of the pipe shaped member 104, it is possible to simply and easily store the magnets 105 into the pipe shaped member 104. In the fifth embodiment, the magnets 105 are arranged to be moved to the position between the opening section 104a of the pipe shaped member 104 and the shaft shaped member 120 parallel in a vertical direction to a longitudinal direction of the pipe shaped member 104. However, the present invention is not limited to this embodiment. When the magnets 105 is moved in parallel with a longitudinal direction of the pipe shaped member 104, for example, parallel movement may be conducted from the direction of 45° against the longitudinal direction of the pipe shaped member 104. Further, in case when the pipe shaped member 104 is horizontally disposed, the magnets 105 may be moved in parallel with the longitudinal direction of the pipe shaped member 104 from the horizontal direction not being limited to the vertical direction or the 45° direction described above. The movement direction when conducting parallel movement is not limited to a specific direction but may be moved from the horizontal direction.

Further, after having conveyed the predetermined number of magnets 105 into the pipe shaped member 104, it is possible to covey the sealing member 140 having the same external dimensions as the magnets 105 by the same method applied to the magnets 105 to seal the pipe shaped member 104. Since the same mechanism for storing the magnets 105 into the pipe shaped member 104 is used, it becomes possible to be a simple structure. The predetermined number of the magnets 105 is a number of necessary magnets corresponding to the conveyance distance of the shaft type linear motor. Basically, the number of necessary magnets can be set by a conveyance distance, for which the linear motor conveys a subject.

Next, the embodiments of a shaft type linear motor, a manufacturing method for the shaft type linear motor, a manufacturing apparatus for the linear motor and a radiation image reading apparatus will be described. However, the present invention is not limited to these embodiments.

The sixth embodiment relates to the shaft type linear motor, the manufacturing method for the shaft type linear motor, the manufacturing apparatus for the linear motor and the radiation image reading apparatus, which have a simple structure, capable of aligning and manufacturing a moving coil with high accuracy and being installed accurately and precisely into an apparatus without adjustments.

More specifically, the shaft type linear motor is as follows.

(1) A shaft type linear motor including

a stator including a pipe shaped member for storing a plurality of magnets, and

a moving element including a coil disposed so as to surround the stator,

wherein the moving element is adhered and fixed onto an attaching member for loading a conveyed object.

With respect to the manufacturing method for the shaft type linear motor, the method is as following.

(2) A manufacturing method for a shaft type linear motor including a stator having a pipe shaped member for storing a plurality of magnets and a shaft type linear motor having a moving element including coils disposed so as to surround the stator, the manufacturing method for a shaft type linear motor including the steps of,

aligning and connecting the plurality of the coils to each other so that the plurality of the coils is disposed with a predetermined intervals to each other, aligned in the same direction and a center of the coil is aligned straight on the same line, and

adhering and fixing the moving element onto an attaching member for loading a conveyed object.

(3) The manufacturing method for a shaft type linear motor wherein step of aligning the plurality of the coils includes the steps of,

inserting a shaft shaped member into the plurality of the connected coils, and

binding and adhering the respective coils in the longitudinal direction of the shaft shaped member by a butting surface provided in the shaft shaped member and a butting member engaged with the shaft shaped member.

(4) The manufacturing method of a shaft type linear motor wherein the step of adhering and fixing the moving element includes the steps of,

assembling a fixing member for holding the shaft shaped member and the attaching member for loading the conveyed object,

assembling the shaft shaped member, which has been inserted into the moving elements, to an assembled fixing member and attaching member,

forming space between the moving element and the attaching member,

moving the assembled shaft shaped member in an axis direction to determine a position of the moving element and

filling adhesive in the space to adhere and fix the moving element to the attaching element.

Further, with respect to a manufacturing apparatus for a shaft type linear motor, it will be as following.

(5) A manufacturing apparatus for a shaft type linear motor having a stator including a pipe shaped member for storing a plurality of magnets, and having a moving element including a coil disposed so as to surround the stator, the manufacturing apparatus including,

a shaft shaped member, which is held in a state where the shaft shaped member is inserted in a moving element including a plurality of connected coils,

a fixing member for holding the shaft shaped member, and

an attaching member for loading a conveyed object,

wherein the fixing member and the attaching member are assembled,

the shaft shaped member, which has been inserted in the moving elements, is assembled to the assembled fixing member and attaching member to form space between the moving element and attaching member,

the assembled shaft shaped member is moved in an axis direction to determine a position of the moving element, and adhesive is filled in the space to adhere and fix the moving element to the attaching element.

(6) The manufacturing apparatus of a shaft type linear motor,

wherein the attaching member includes a concave section, into which the a part of the moving element enters, and a position determination member for conducting a position determination by moving the moving element in a axis direction to butt the part of the moving element to a reference surface of the concave section after forming space between opposed surfaces of the part of the moving element and the concave section.

With respect to the radiation image reading apparatus, it will be as follows.

(7) An radiation image reading apparatus including the shaft type linear motor of item (1) as a driving source.

Thus, according to the item (1), since the moving element is adhered and fixed onto the attaching member, onto which a conveyed object is loaded, and the structure is simple, it is possible to easily install the moving element with high accuracy in case when installing the shaft type linear motor into office automation equipment and medical equipment.

According to item (2), the moving element is manufactured by aligning and connecting the plurality of the coils to each other so that the plurality of the coils are disposed with a predetermined intervals to each other and aligned in the same direction and the center of the coil is aligned straight on one line. Further the moving element is adhered and fixed onto an attaching member for loading a conveyed object. Thus, it becomes possible with a simple structure without adjustment to manufacture the coil of moving element with high accuracy having a predetermined coil pitch, and the moving element can be easily installed into an apparatus with high accuracy.

According to the item (3), the moving element is bound in a longitudinal direction by a butting surface provided in the shaft shaped member and a butting member engaged with the shaft shaped member, and adhered by adhesive. Further moving element can be manufactured by aligning a plurality of the connected coils so as to be aligned with a predetermined coil pitch. Thus it becomes possible to regulate phase irregularity between magnets and coils. Further, by aligning the inner diameter of respective coils with high accuracy by utilizing the shaft shaped member not to have position irregularity, the space between respective coils and the stator can be even.

According to item (4), by forming space between the moving element and the attaching member, moving the assembled shaft shaped member in an axis direction to determine a position of the moving element and filling adhesive in the space to adhere and fix the moving element to the attaching element, the position accuracy of the moving element with respect to the attaching member can be secured and the moving element can be fixed at a predetermined position only with the accuracy of the part.

According to item (5) by holding a moving element including a plurality of connected coils in a state that the shaft shaped member is inserted in the moving element including a plurality of connect coils and forming space between the moving element and the attaching member for loading conveyed object, adhesive is filled into this space to adhere and fix the moving element to the attaching member. As described above, the process for manufacturing the moving element and the process for attaching the moving element to the attaching member are conducted on a successive process. Thus the workability is superior.

According to item (6), by forming space between opposed surfaces of the part of the moving element and the concave section of the attaching member and butting a part of the moving element in an axis direction to a reference surface in the concave section for positioning, the position accuracy of coil of the moving element with respect to the attaching member can be secured and the moving element can be fixed at a desired position only with accuracy of parts.

According to item (7), since the shaft type linear motor of item (1) is used as the drive source, the shaft type linear motor can easily be installed with high accuracy and a superior image can be obtained in the radiation image reading apparatus, where particularly a severe image quality is required.

FIG. 23 illustrates a schematic diagram of the shaft type linear motor. A shaft type linear motor 210 includes a stator 220 having a pipe shaped member 221 storing a plurality of magnets and a moving element 230 having coils formed by wound wire so as to surround the stator 220. The stator 220 includes a plurality of magnet 224 and a pipe shaped member 221 for storing the plurality of magnets 224. The magnet 224 is preferably formed in a cylindrical shape so as to be efficiently stored into the pipe shaped member 221. However, as long as the external shape is cylindrical, the magnet having a hole passing through the center of the magnet may be used. With respect to the material of magnet 224, a rare-earth magnet having a large magnetic flux density is preferable. Particularly, with respect to the rare-earth magnet, neodymium system magnet, for example, a Neodymium-Iron-Boron magnet (Nd—Fe—B magnet) is preferable. Comparing with other magnets, higher thrust can be obtained.

With respect to the material of the pipe shaped member 221, an aluminum alloy, cupper alloy and non-magnetic material, such as non-magnetic stainless steel are preferably used. Further, the pipe shaped member 221 is preferably thinner so as not to reduce magnetic field, which acts on the moving element 230. In this embodiment, a thin-thickness pipe is used. By using this thin-thickness pipe, the distance between the magnet 224 and the moving element 230 can be short to obtain larger thrust.

One end of the pipe shaped member is closed and a screw section 222 is integrally provided. Further, the other end of the pipe shaped member 221 is open to store magnets 224 in the pipe shaped member 221 and a cap 223 is provided to close the opening. The cap 223 can be formed by using non-magnetic material as the same as the pipe shaped member 221.

In the pipe shaped member 221, a plurality of magnets 224 are stored with the same magnetic poles being opposed to each other so that the adjacent magnets are repelling each other. Here, the adjacent magnets 224 are stored in the pipe shaped member 221 so as to be closely contacted to each other. However, as long as the adjacent magnets 224 are stored so as to be repelling each other, the space may be provided between adjacent magnets 224 themselves. The cap 223 regulates the magnets 224 to be ejected from the both sides of the pipe shaped member 221 by the repelling force.

In this invention, a moving element 23 is structured so that the plurality of the coils 231 are disposed with a predetermined interval to each other and aligned in the same direction. The center of the plurality of coils 231 is aligned straight on one line. There is no special restriction to the structure of this coil 231. By disposing a plurality of connected coils 231 with a predetermined interval and a desired coil pitch, the phase irregularity of the magnets 224 can be suppressed. By aligning the inner diameter 231a of respective coil 231 with high accuracy so that the axis center of the coil 231 is straight on one line, the space between respective inner diameters 231a of the coils 231 and the pipe shaped member 221 of the stator 220 can be even.

In this invention, the moving element 230 is adhered and fixed onto the attaching member 225 for loading the conveyed object. As described above, the moving element is adhered and fixed onto the attaching member 225. In case when installing the shaft type linear motor 210 into apparatuses such as office automation equipment and medical equipment, the shaft type linear motor 210 can be easily assembled to them without fine adjustment and with only accuracy of parts of the attaching member 225. Further, the space between the stator 220 and the moving element 230 can be kept constant with only part accuracy. Thus, the stator 220 will not touch with the moving element 230, which improves the conveyance performance.

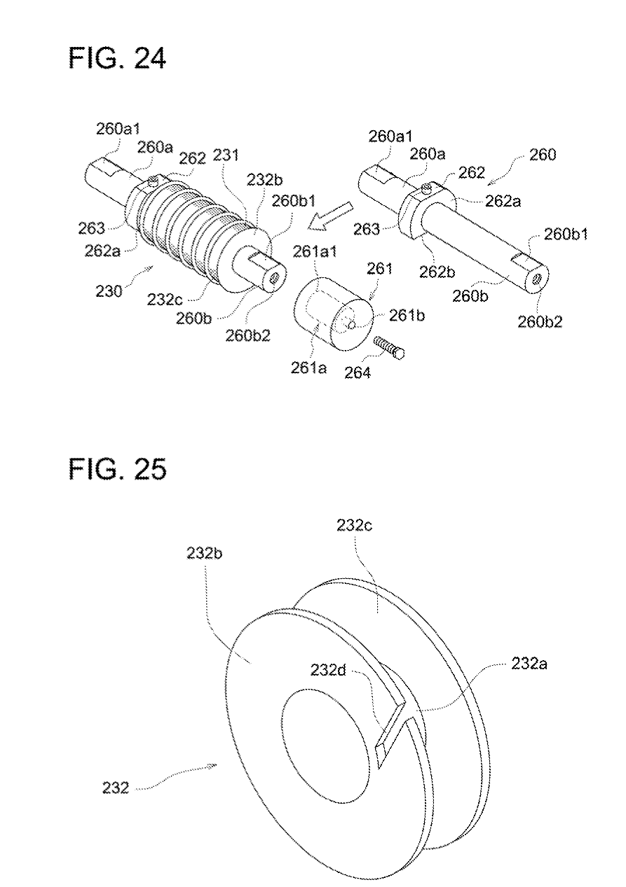

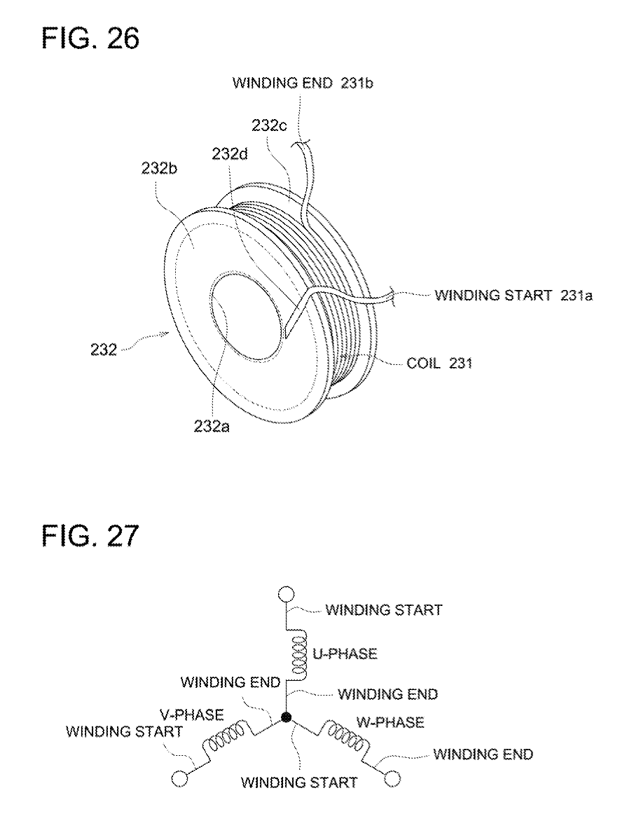

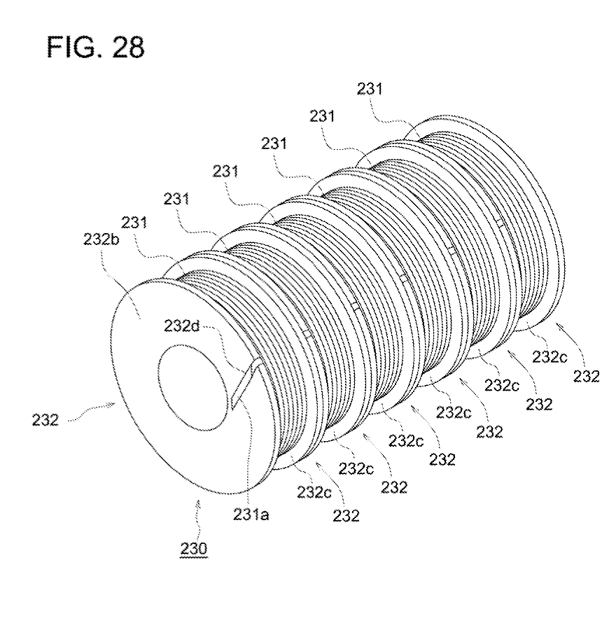

Next, an embodiment of a moving element manufacturing process for manufacturing the moving element 230 by connecting a plurality of the coils 231 so as to be disposed with a predetermined intervals to each other and aligned in the same direction, the center of the coil being aligned on the same straight line, will be described by using FIGS. 24-28. FIG. 24 illustrates a manufacturing process of a moving element. FIG. 25 illustrates a perspective view of a cylindrical member having a brim. FIG. 26 illustrates a perspective view of the cylindrical member having a brim around which a wire has been wound. FIG. 27 illustrates a wire connection of the coil. FIG. 28 illustrates a perspective view of the structure where a plurality of cylindrical members having brims including coils is connected with each other.

In the moving element manufacturing process in FIG. 24, the moving coil 230 is manufactured by using a shaft type member 260 and a butting member 261 and by aligning and connecting a plurality of the coils 231 so that the plurality of the coils are disposed with a predetermined intervals to each other, aligned in the same direction and the center of the coil is aligned on the same straight line. Butting surface sections 260a1 and 260b1 have been formed on a part of circumference surface on the both end sections 260a and 260b of the shaft shaped member 260. Further, a female screw 260b2 has been formed at the end section 260b.

The shaft shaped member 260 is inserted into a position determination member 262 and this position determination member 262 is fixed onto the shaft shaped member 260 at a position on the end section 260a side by a bolt 263. This position determination member 262 includes the butting surface 262a on the side section of the end section 260a and flank face 262b on a lower portion. In this embodiment, the position determination member 262 can be removed by removing the bolt 263 from the shaft shaped member 260.

An open engaging hole 261a has been formed on one end 261a1 of the shaft section of the butting member 261. The size of this engaging hole 261a is arranged to be engaged with the end section 260b of the shaft shaped member 260. A screw insertion hole 261b connected to the engaging hole 261a has been formed on the shaft section of the butting member 261.

The shaft shaped member 260 is inserted in the structural members of the moving element 230. In the state where the structural members of the moving element 230 are assembled, the engaging hole 261a of the butting member 261 to the end portion 260b is engaged, the tightening screw 64 is inserted into the screw inserting hole 261b, the structural member of the moving element 230 is bound by the butting member 261 and the butting surface 262a by driving the tightening screw 64 to the female screw 260b2 on the end portion 260b, and a plurality of coils 231 are aligned and connected so that the plurality of coils 231 is arranged to have a predetermined interval and to be aligned in the same direction, and the shaft center is aligned on the same straight line to connect and manufacture the moving coils 230. As described above, since the inner diameter dimension of the a plurality of coils 231 can be manufactured with high accuracy (without dispersion), by inserting the shaft shaped member 260 to the plurality of coils 231 and connecting (adhering) them to each other, as a result, the axis centers of the respective coils can be on the same straight line.

As illustrated in FIG. 28, the moving coil 230 is structured by connecting a plurality of cylindrical member having brims 232 and including coil 231 formed by winding wire thereon. These cylindrical members having brims 232 are connected to each other with an adhesive. In this embodiment, coil 231 is structured (connected) by two set structure where one set structure is formed by U-phase, V-phase and W-phase. When necessary, the number of sets may be changed.

The cylindrical member having brims 232 is structured as illustrated in FIGS. 25 and 26. The cylindrical member having a brim 232 includes a cylinder section 232a and brims 232b and 232c provided on the both side of the cylinder section 232a. The dimension of the width direction of the brims of the both ends of this cylindrical member having brims 232 is equal to one third of the magnet pole pitch of the magnet 224 of the stator 220. The motor performance can be secured only by the part accuracy of the motor.

As illustrated in FIGS. 24 and 25, in this cylindrical member having brims 232, a slit 232d is formed in a straight shape from adjacent to the cylinder portion 32b1 to the circumference portion 32b2 at least with one of the side surface, in this embodiment, with the brim 232b.

As winding start 231a of the wire winding starts from the edge section of the cylinder section 232a and reaches to the end section on an opposite side. Then winding wire returns toward the winding start 231a side while wire is wound in a pile structure. Based on the repeating operations, the coil 231 illustrated in FIG. 26 is structured. The winding start 231a of wire is arranged to take out from the slit 232d and the winding end 231d is arranged to end at the outer surface of winding wire. Since the slit 232d, which has the width dimension the same as the outer diameter of the wire to be wound, is provided on the brim 232b in the side surface of the cylindrical member having a brim 232, when pulling out the winding start 231a, it is possible to pass through the slit 232d. Thus, when pulling out the winding start 231a is arranged to pass through the slit 232d, but does not pass through inside surface of the brim 232b, it is possible to prevent the cylindrical member having a brim 232 from deforming and to efficiently wind and align the wire.

Further, since the number of winds in a row of the coil 231 increases, the diameter of the coil 231 becomes smaller when winding has finished. Thus, since the efficiency of the mutual action caused by the magnetic flux generated from the stator 220 and the magnetic field generated by the coil 231 improves, it becomes advantage from the motor performance point of view.

In the cylindrical member having brims 232 including the coil 231 formed by winding the wire thereon, as illustrated in FIG. 27, three phase, such as U-phase, V-phase and W-phase are connected so that, for example, the winding ends of U-phase, V-phase are connected to the winding start of W-phase by soldering. A plurality of the cylindrical member having brims 232 including the coil 231 formed by winding wire thereon can easily be connected, for example, by adhesive. In case when applying, so to speak, a mat process on the cylindrical member having brims 232, the adhesive performance (or strength) of the side surface of the cylindrical member having brims 232 will be improved.

In this embodiment, in case when connecting a plurality of the cylindrical member having brims 232 including the coil 231 formed by winding the wire thereon, the winding start 231a has to be taken out. However, by providing the slit 232d, the coil pitch can be secured with high accuracy. Further, since the winding start 231a of wire is not layered, it is possible to efficiently align and wind the wire.

In the moving element 230 as illustrated in FIGS. 25-28, the coil 231 is formed by winding wire around the cylindrical member having brims 232. The moving element 230 is structured by connecting the cylindrical members including brims 232 having these coils 231 to each other as illustrated in FIG. 28. Thus, it is not necessary to conduct fine adjustment because the pitch of the coil 231 is determined with part accuracy. By changing the number of connected cylindrical members including brims 232 having coils 231, obtained thrust can easily be changed. Further, the degree of insulation of respective coils 231 can be secured by the cylindrical member having brims 232.

In the shaft type linear motor 210 of this embodiment, the moving element 230 is structured as following. That is, a unit is assembled by winding wire around the cylindrical member having brims 232 whose thickness is thin, with a predetermined number of turns. Then the necessary number of the units are adhered and connected. The number of necessary units is determined by corresponding to the conveyance force of the shaft type linear motor 210. Basically the number of units is set by a set-number based on the U-phase, V-phase and W-phase deemed as one set.

At that time, by finishing the internal dimension of the cylindrical section 232a of the cylindrical member having brims 232 with high accuracy, the shaft shaped member 260 can be inserted into the inner diameter of the unit of the cylindrical member having brims 232 with high accuracy. By inserting this shaft shaped member 260 to the necessary number of units of the cylindrical member having brims 232 and binding and closely contacting the cylindrical member having brims 232 to each other, the total length dimension can be determined with high accuracy in the case when connecting a plurality of units of the cylindrical member having brims 232 are connected.

In this embodiment, the moving element 230 is formed into a simple configuration by binding a plurality of the cylindrical member having brims 232 and adhering the plurality of the cylindrical members having brims 232 themselves in the longitudinal direction of the shaft shaped member 260. By structuring the moving element 230 with a predetermined coil pitch, the phase irregularity between the moving coil and the magnets 224 can be regulated. Further, by manufacturing the moving element 230 so that the axis center of respective coils are aligned and connected on the same straight line, the space between the stator and the moving element 230 can be evenly secured.

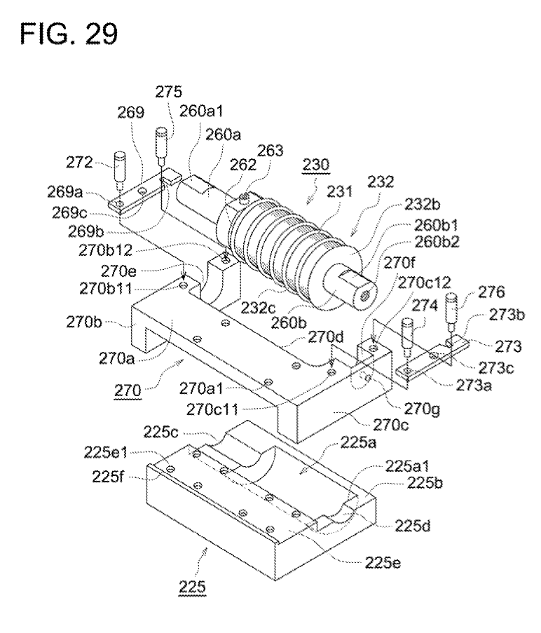

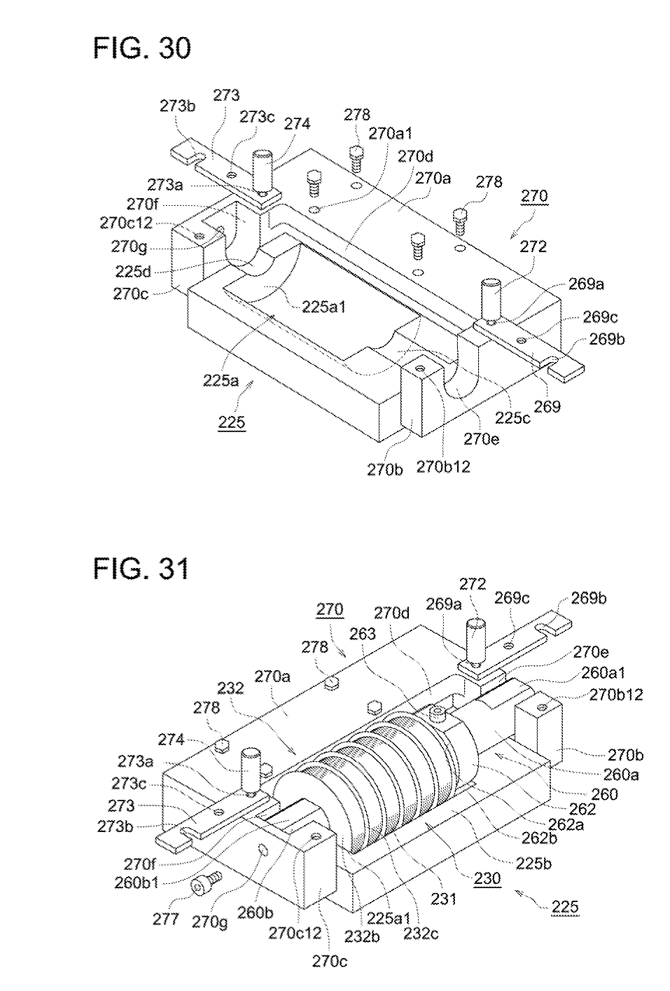

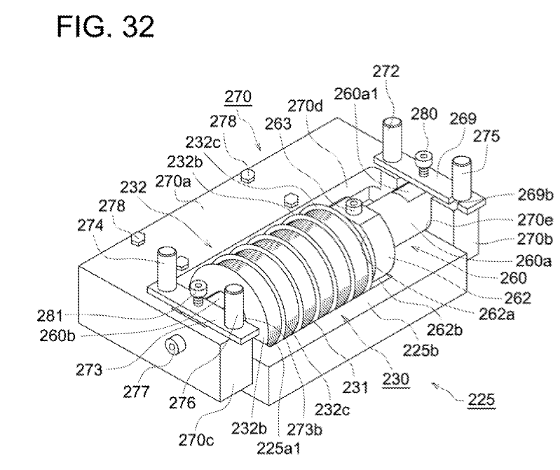

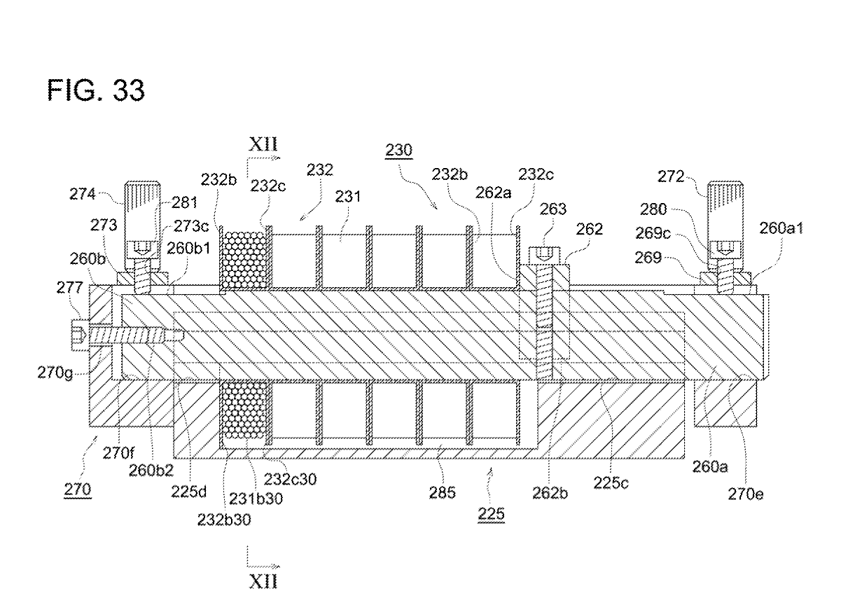

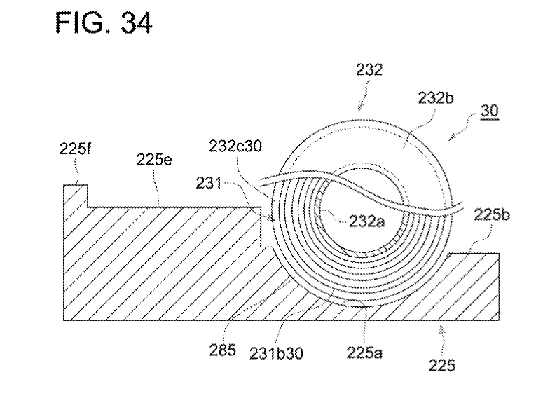

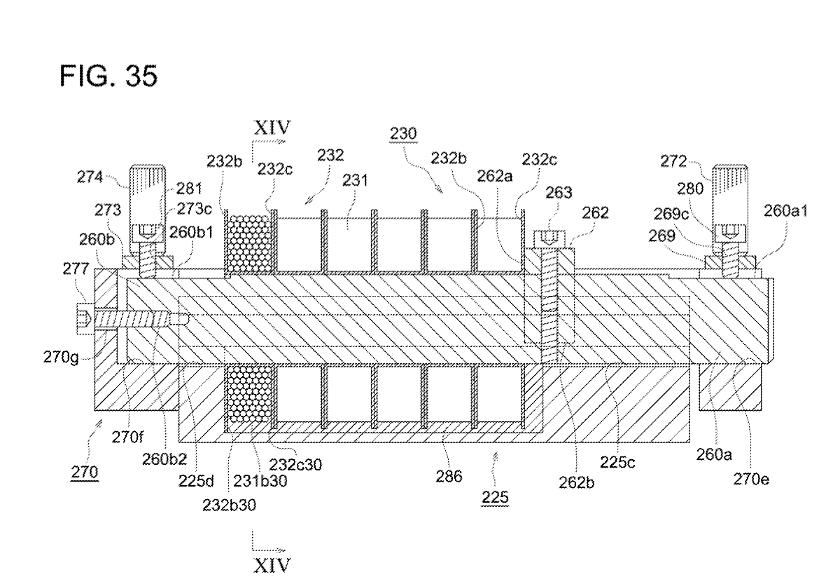

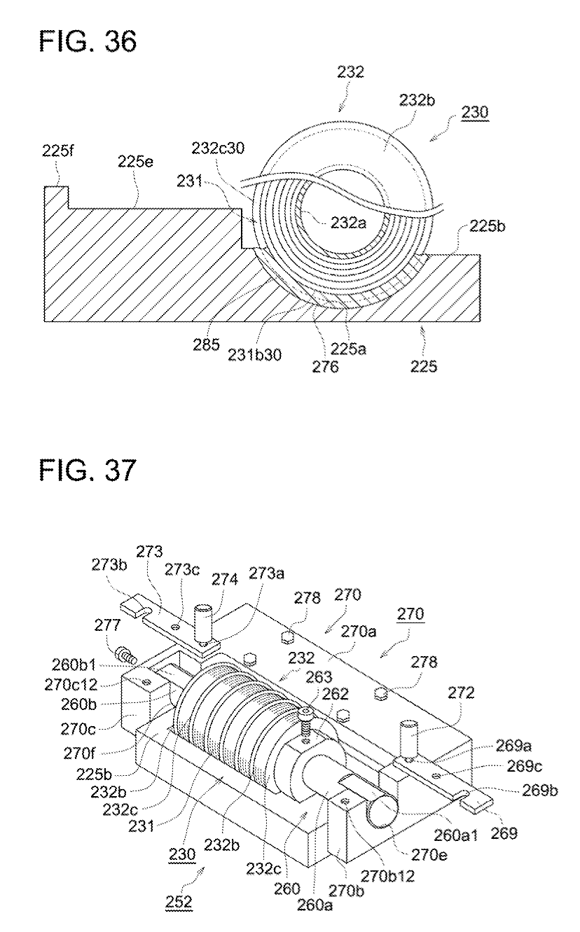

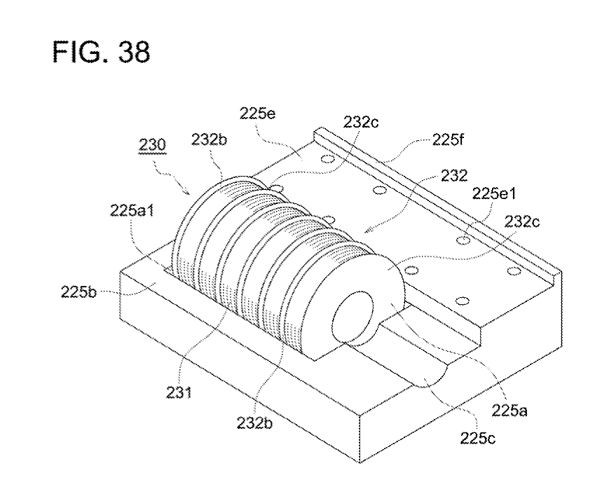

Next, the moving element adhesive fixing process for adhering and fixing the moving element onto the attaching member for loading a conveyance object will be described by referring to FIGS. 29-39. FIG. 29 illustrates a moving element adhesive fixing process. FIG. 30 illustrates a perspective view of situation where a fixing member and an attaching member are combined. FIG. 31 illustrates a perspective view of a situation where a shaft shaped member, which has been inserted in a moving element, is attached to an assembled fixing member and the attached member. FIG. 32 illustrates a perspective view of a situation where positioning is conducted while holding the moving element. FIG. 33 illustrates a cross sectional view of a situation where the moving element has been attached. FIG. 34 illustrates a cross sectional view along a line of XII-XII in FIG. 33, from which the fixing member has been omitted. FIG. 35 illustrates a cross sectional view at the same position as FIG. 33 in which adhesive has been filled. FIG. 36 illustrates a cross sectional view along a line of XIV-XIV in FIG. 35, from which the fixing member has been omitted. FIG. 37 illustrates a perspective view of a situation where a shaft shaped member is removed. FIG. 38 illustrates a cross sectional view of a situation where the moving element has been fixed into the attaching member.

In this moving element adhesive fixing process, the moving element 230 is adhered and fixed onto the attaching member 225 by using the attaching member for loading a conveyed object, which is a pedestal, and a fixing member 270 for holding a shaft shaped member as jigs. Firstly, the fixing member 270 and the attaching member 225 are combined. Then, the shaft shaped member 260, in the state that the shaft shaped member 260 has been inserted in the moving element 230, is assembled to the combined fixing member 270 and attaching member 225.

The attaching member 225 includes a concave section 252a having a rectangular shape, into which a part of the moving element 230 is inserted, a flat surface 252b formed around the concave section 252a, a flank concave sections 225c and 225d located in both sides of the longitudinal direction of the concave section 252a, a step section 225e for holding the fixing member 270 and a positioning rib 225f formed along this step section 225e. The flank concave sections 225c and 225d are formed to avoid interferences with the fixing element 220. However, it is also arranged to avoid the interferences with the shaft shaped member 260 which is a jig. Substantially a half of the moving element 230 has entered into the concave section 252a. The concave section 252a is formed to be large so that the outer circumference surface of the moving element 230 does not touch with the concave section 252a. This concave section 252a includes a reference surface 225a1 for butting a part of the moving element 230 in the axis direction to conduct positioning. Further, the step section 225e becomes the reference surface for holding the fixing member 270. A plurality of attaching female screw holes 225e1 are formed on this step section 225e. The female screw holes 225e1 of the step section 225e are used for attaching the fixing section 270 and the attaching member 225. Further, the female screw holes 225e1 of the step section 225e are used for loading a conveyed object.

The fixing member 270 is formed into a frame structure to be assembled to the attaching member 22S. The fixing member 270 includes a flat section 270a, wall sections 270b and 270c located in the both sides in the longitudinal direction of the flat section 270a, a cut section 270d formed in the flat section 270a, a holding concave section 270e for holding the shaft shaped member 260 formed on the wall section 270b, a holding concave section 270f for holding the shaft shaped member 260, formed on the wall section 270c and a communication hole 270g for communication with the holding concave section 270f. A plurality of screw inserting holes 70a1 is provided with the flat surface section 270a. A plurality of screw inserting holes 70a1 is used for assembling the fixing member 270 and the attaching member 225. Female screw holes 270b11 and 270b12 are formed on both sides of the holding concave section 270f on the wall section 270b. Female screw holes 270c11 and 270c12 are formed on both sides of the holding concave section 270f on the wall section 270c. The female screw holes 270b11, 270b12, 270c11 and 270c12 are used to fix the shaft shaped member 260.

In this moving element adhesive fixing process, as illustrated in FIG. 30, firstly, the fixing member 270 is assembled onto the attaching member 225. In this assembly, the attaching member 225 is inserted between the wall sections 270b and 270c of the fixing section 270 and the flat surface 270a is positioned on the surface of step section 225e. The side surface of the flat surface 270a is fixed by a position determination rib 225f of the attaching member 225 not to be shifted. These position determination rib 225f and step section 225e become reference surfaces. By inserting and driving a attaching bolt 278 into the attaching female screw hole 225e1 of the fixing member 270 through the screw inserting hole 70a1 of the attaching member 225, the attaching member 225 is driven tight with the fixing member 270.

A holding plate 269 is held onto the wall section 270b on the fixing member 270, the attaching jig 272 is inserted from the attaching hole 269a of a holding plate 269, the attaching jig 272 is driven into the female screw hole 270b11 so that the holding plate 269 is softly attached so as to rotate centering on the attaching jig 272. Further, a holding plate 273 is held onto the wall section 270c, an attaching jig 274 is inserted from the attaching hole 273a of the holding plate 273, the attaching jig 274 is driven into the female screw hole 270c11 so that the holding plate 273 is softly attached so as to rotate centering on the attaching jig 274.

Next, as illustrated in FIGS. 31-34, the moving element 230 manufactured on the moving element manufacturing process is installed onto the fixing member 270 under the situation where the shaft shaped member 260 has been inserted to the moving element 230. In this assembly, the shaft shaped member 260 is placed on the fixing member 270 so that a part of the moving element 230 enters from the cut section 270d to the concave section 252a of the attaching member 225. The edge section 260a of the shaft shaped member 260 touches with holding concave section 270e to determine the position in the vertical direction. The edge section 260a is arranged not to interfere with the flank concave section 225c. Similarly, the edge section 260b touches the holding concave section 270f to determine the position in the vertical direction. The edge section 260b is arranged not to interfere with the flank concave section 225d. The flank surface 262b of the position determination member 262 provided on the shaft shaped member 260 is positioned not to touch with the flat surface section 252b of the attaching section 225.

Next, the attaching jig 275 is softly driven to the female screw hole 270b12 on the fixing member 270 and similarly the attaching jig 276 is softly driven to the female screw hole 270c12. The holding plate 269 is rotated to attach a cut portion 269b to the softly screwed attaching jig 275 and tighten the respective attaching jigs 272 and 275. Further, the holding plate 273 is rotated to attach the cut portion 273b to the softly screwed attaching jig 276 and tighten the respective attaching jigs 274 and 276.

Screw holes 269c and 273c are provided on the holding plates 269 and 273. Bolts 280 and 281 are softly screwed to softly hold the butting surfaces 260a1 and 260b1 of the shaft shaped member 260 to prevent the shaft shaped member 260 from floating.

Then, the bolt 277 is inserted from the communication hole 270g of the fixing member 270 to drive it to the female screw hole 260b2 on the shaft shaped member 260. As illustrated in FIGS. 32 and 33, the assembled shaft shaped member 260 is moved in the axis direction by being pulled by the tightening of the bolt 277. Then the brim 232b of the cylindrical member having brims 232, which is a part of moving element 230 in the axis direction, is butted to the reference surface 225a1 of the concave section 252a of the attaching member 225 and the position is determined. Then the softly screwed bolts 280 and 281 are strongly tightened. Based on this operation, the front end section of the bolts 280 and 281 hold and fix the butting surface sections 260a1 and 260b1 of the shaft shaped member 260.

As described above, the fixing member 270 is attached to the attaching member 225, which becomes a pedestal, and the moving element 230, into which the shaft shaped member has been inserted, is installed to this attached fixing member 270. Based on this assembly, as illustrated in FIGS. 33 and 34, the space 285 is formed between the external surface 231b30 of the coil 231 and the external surfaces 232b30 and 232c30 of the brims 232b and 232c, and the concave section 252a of the attaching section 225. Adhesive 286 is filled into this space 285 to a degree not to be leaked out from the concave section 252a of the attaching member 225. As illustrated in FIGS. 35 and 36, adhere and fix the external surface 231b30 of the coil 231 and the external surfaces 232b30 and 232c30 of the brims 232b and 232c onto the concave section 252a of the attaching member 225. As described above, after filling the adhesive 286 into the space 285 and having fixed the moving element 230 onto the attaching member 225, as illustrated in FIGS. 37 and 38, holding plates 269 and 273 are removed. Then the bolt 263 of the shaft shaped member 260 is removed to allow the shaft shaped member 260 to be removed from the position determination member 262. Then the shaft shaped member 260 is removed from the end section 260a side after having removed a bolt 277. After having removed the shaft shaped member 260, the fixing member 270 is removed from the attaching member 225 by removing a bolt 278. Then, as illustrated in FIG. 38, the moving element 230 is adhered and fixed onto the attaching member 225.

As described above, since the process for manufacturing the moving element and the process for attaching the moving element onto the attaching member can be continuously conducted by maintaining the state that the shaft shaped member 260 has been inserted to the moving element 230, forming the space 285 between the attaching member 225 and the external surface of the moving element 230 structured by the external surface 231b30 of the coil 231 and the external surfaces 232b30 and 232c30 of the brims 232b and 232c, and filling adhesive 286 into the space to attach the moving element 230 to the attaching member 225, workability is superior.

Further, in case when winding wire for the coil 231, since the wire is to be wound around the shaft shaped member 260, the dimension accuracy of the inner diameter can be high (without irregularity). However, the dimension of the outer diameter may disperse based on the diameter of the wire to be wound and the tension when wire is wound. Thus, in the case when aligning the coil 231 based on the external dimension, there is a strong possibility/that the axis center of the coil cannot be aligned. Accordingly, space is provided between the outer surface of the moving element 230 and the attaching member 225 in order not to cause the interference between them. The position determination with respect to the attaching member 225 is conducted based on the reference of inner diameter dimension. Accordingly, there is an advantage that the part accuracy of the concave section 225 of the attaching member 225 is not needed to be severely controlled. When assuming that a coil 231 had been manufactured so that the external dimension does not disperse and based on the coil external dimension, the part accuracy of the concave section 252a of the attaching section 225 largely affects the performance. However, by forming the space 285 between the external surface of the moving element 230 and the attaching member 225, it is not necessary to strictly control the part accuracy of the concave section 252a of the attaching member 225.

Further, by moving the assembled shaft shaped member 260 in the axis direction and butting a part of the moving element 230 in the axis direction to the reference surface 225a1 of the attaching member 225 to conduct positioning, filling the adhesive 286 in the space 285 and fixing the moving element 230 to the attaching member 225, it is possible to secure the position accuracy of the moving element 230 in the axis direction with respect to the attaching member 225. Further, it is possible to fix the moving element 230 at a desired position with only part accuracy.

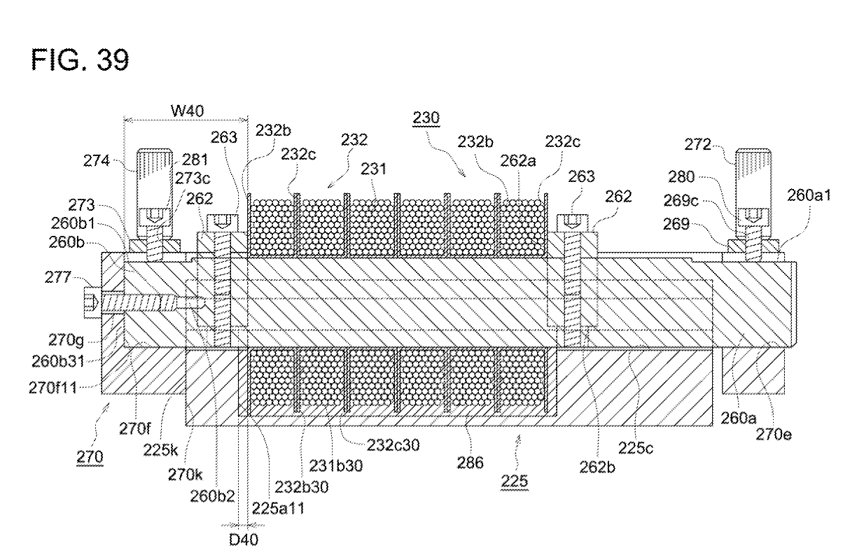

The position determination of the moving element 230 is not limited to the method of butting the moving element 230 onto the reference surface 225a1 provided on the attaching member 225. As illustrated in FIG. 39, by butting an end surface 25k of the attaching member 225 to an end surface 70k of the fixing member 270 and tightening the bolt 277, the shaft shaped member 260 is pulled and shifted in the axis direction and the end surface 260b31 of the shaft shaped member 260 butt into the end surface of 270g11 of the holding concave section 270f of the fixing member 270. Based on this operation, the position of the moving element 230 can be determined. In this embodiment, the position determination members 262 are provided on both sides of the moving element 230 in order that the moving element 230 does not move in the axis direction of the shaft shaped member 260. By defining the a distance W40 between the end surface of 270f11 of the holding concave section 270f and the brim 232b so as to provide space D40 between the surface 225a11 of the attaching member 225 and the brim 232b, the position accuracy in the axis direction of the moving element 230 with respect to the attaching member 225 can be secured. Further, the moving element 230 can be fixed at a desired position with only part accuracy.

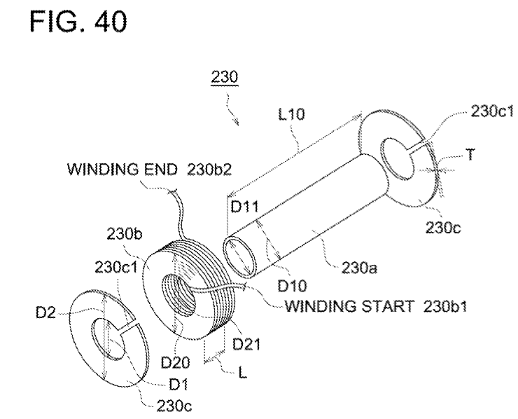

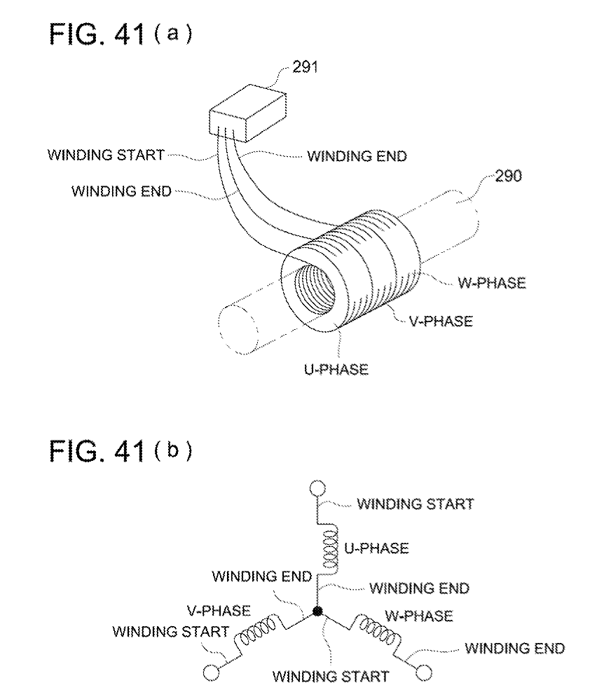

Next, another embodiment of the moving element manufacturing process will be illustrated in FIGS. 40 and 41. FIG. 40 illustrates a perspective view of a structural part of the moving element. FIG. 41 illustrates a connection drawing of the coil.

In the moving element manufacturing process illustrated in FIG. 24, the moving element 230 is manufactured by using the shaft shaped member 260 and the butting member 261 as jigs to align the inner diameter of a plurality of coils. However, as illustrated in FIG. 39, the moving coil 230 of this embodiment includes a tube shaped member 230a extending in the axis direction, a plurality of air-core coils 230b to be inserted to the tube shaped member 230a and a partition plate 230c disposed between at least a plurality of air-core coils 230b.

In this embodiment, partitions are provided between a plurality of the air-core coils 230b, and the tube shaped member 230a is inserted through the air-core coil 230b under the state that the partition plate 230c is provided between a plurality of air-core coils 230b and the partition plates 230c are provided in both sides. This air-core coil 230b is structured by two sets of coils (connected) where one set of coils is structured by U-phase, V-phase and W-phase. The number of sets can be changed if necessary.

The tube shaped member 230a is formed into a cylinder. An inner diameter D11 of the tube shaped member 230a is a size, which makes it possible that the shaft shaped member 260 can be inserted into it. The material of the tube shaped member 230a may be resin or aluminum, onto which black alumite treatment has been applied, by which insulation capability is secured. With respect to the tube shaped member 230a, the dimensions of an outer diameter D10 and a length L10 are set according to the capacity of motor as illustrated in FIG. 40. Further, the outer diameter D10 of the tube shaped member 230a has a dimension, which fits an inner diameter D21 of the air-core coil 230b. By arranging so that the outer diameter D10 of the tube shaped member 230a fits the inner diameter D21 of the air-core coil 230b, the insulation properties of the inner diameter side of respective air-core coils 230b can be secured and the inner surfaces of a plurality of air-core coils 230b can be aligned with high accuracy. Further, the motor performance and the workability can be improved. Here, D20 denotes the outer diameter of the air-core coil 230b.

As illustrated in FIG. 41, respective air-core coil 230b is structured by winding wire onto a shaft shaped jig 290 in a coil production process and coils are manufactured for three phases of U-phase, V-phase and W-phase. The wires for these air-core coils 230b for three phases of U-phase, V-phase and W-phase are, for example, connected by soldering at the winding ends of U-phase and V-phase and the winding start of W-phase. The rest of end sections are connected with a connector 291 and after that a shaft shaped jig 290 is removed.

The respective air-core coils 230b have the winding start 230b1 of wire and winding end 230b2 of the wire so that the winding start 230b1 is arranged to be inside and the winding end 230b2 is arranged to be outside. Single unit of the coil is structured as the air-core coil 230b. This air-core coil 230b is structured by a cupper line having a fusion layer on the surface thereon. Since the air-core coil 230b can be formed only by wire, workability is high. Further, since cost can be reduced, it has advantages.

The partition plate 230c is structured into a disk shape. The material may be resin or aluminum, to which black alumite treatment has been applied, by which insulation capability is secured. The dimension of the inner diameter of this partition plate 230c is D1 and the dimension of outer diameter is D2. The partition plate 230c has a coil clearnce section 230c1, into which the winding start 230b1 of wire can be inserted, is provided. This clearance section 230c1 is formed by a slit structure or a groove structure. The clearance section 230c1 of this embodiment is a radial slit starting at the inner diameter D1 and ending at the outer diameter D2. Since the winding start 230b1 can be inserted into the clearance section 230c1 to let the winding start 230b1 escape from the space beside the partition plates 230c, it is possible to let the air-core coil 230b and the partition plate 230c closely contact each other with high accuracy.

In this embodiment, as illustrated in FIG. 40, in the case when the width of the air-core coil 230b is set L, the thickness of the partition plate 230c is set T and a desired coil pitch is set P, the formula, P=L+T is satisfied. An arbitrary desired coil pitch P can be secured.

The air-core coil 230b and the partition plate 230c are fixed to the tube member 230a having a thin-thickness inserted in them so that the tube shaped member 230a closely contacts the inner side of the air-core coil 230b and the partition plate to be adhered, which makes a simple structure. The partition plate 230c is inserted between respective air-core coils 230b. This partition 230c realizes the accuracy of the coil pitch P and the insulation between coils.

In the case of air-core coil 230b, the winding start 230b1 has to be pull out. However, by providing the clearance portion 230c1, it is possible to avoid an overlap. Further it is possible to regulate the deformation of the partition plate 230c and at the same time, to secure the coil pitch with high accuracy.

The moving element 230 has a structure, in which the tube shaped member 230a has been inserted, with the partition plates 230c deployed between plural air-core coils 230b. By changing the number of the air-core coils 230b to be connected to each other, obtained thrust can easily be changed. Further, the insulation property of each air-core coil 230b can be secured by the partition plate 230c.

The shaft type linear motor 210 of this embodiment has a structure so that the tube shaped member 230a extending in the axis direction has been inserted into moving element 230 with the partition plates 230c deployed between plural air-core coils 230b. The necessary number of the air-core coil 230b is determined corresponding to the conveyance force of the shaft type linear motor 210. Basically, the required number of the air-core coils 230b is set by the necessary conveyance force of the shaft type linear motor 210.

In this embodiment, the air-core coils 230b and the partition plates 230c are bound in the longitudinal direction of the shaft shaped member 260 and the air-core coils 230b and the partition plates 230c are adhered to form the moving element 230 having a simple structure.

By selecting a desired coil pitch, the phase shifting between the moving element 230 and the magnet 224 can be regulated. Further, by aligning the inner diameter of the air-core coil 230b with high accuracy, the space between the coil and the stator can be uniformly secured. The dimension in the width direction of this air-core coil 230b has been manufactured with a predetermined dimension in advance. However, in the case when the dimension in the width direction of this air-core coil 230b cannot be secured to be a predetermined dimension in advance by manufacturing due to influence from wire, by utilizing the spacer corresponding to the generated space, a required coil pitch can be realized.

The moving element 230 manufactured by the embodiment other than process illustrated in FIGS. 40 and 41, is fixed on the attaching member 225 for loading the moving element 230 and a conveyed object, in the same way as the embodiment illustrated in FIGS. 29-39. Other embodiments may be acceptable as long as it is formed by inserting a shaft shaped member to the inner diameter of the plural connected coils of moving elements 230, and binding and adhering the respective coils in the longitudinal direction by using the butting surface provided on the shaft shaped member and butting member engaging with the shaft shaped member.

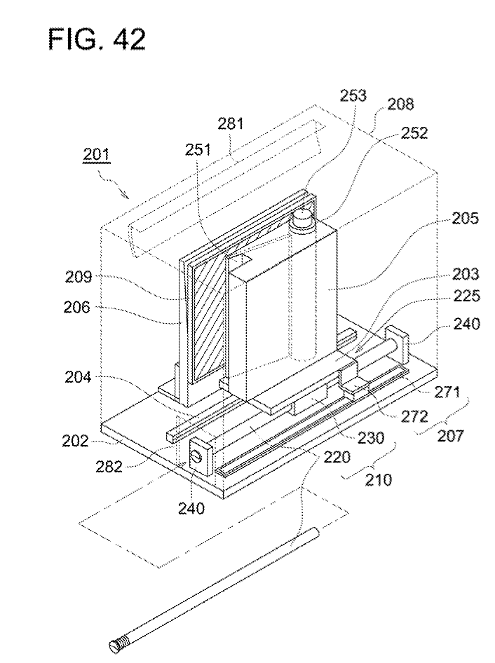

The shaft type linear motor 210 of this embodiment can be utilized as a driving source of the radiation image reading apparatus. The embodiment of this radiation image reading apparatus is illustrated FIG. 42.

The radiation image reading apparatus 201 includes an optical unit 205, a conveyance table 203, the shaft type linear motor 210, a straight moving guide 204, a linear encoder 207, a plate support section 206 as main structural elements, and further includes a base 202 supporting these elements and an external cover 208 for covering those elements. In this embodiment, a radiation image reading apparatus 1, in which the shaft type linear motor 210 conveys the optical unit 205 will be described. However the present invention is not limited to this embodiment. It may be acceptable to convey the photostimulable phosphor plate 209 instead of the optical unit 205.

Upper portion of the base 202, there are provided the shaft type linear motor 210, the conveyance table 203, the straight moving guide 204, the linear encoder 207, the optical unit 205 and the plate support section 206.

The shaft type linear motor 210 is structured by a stator 220 having a pole shape and a moving element 230. The stator 220 stores a plurality of magnets 224 inside the pipe shaped member 221 so that adjacent magnets 224 repel to each other and both ends are held on the stator holding sections 240, with the both ends being held in parallel with the base 202. The stator 220 is inserted into the center of the moving element 230. This is the attaching structure of the stator 220 to the stator holding section 240.

The moving element 230 is fixed onto lower surface of the conveyance table 203. Coils are stored inside the moving element 230. With respect to the coil, multiple phases, for example, the coil group configured by three phases can be utilized. However, it is not limited to this. Further, an insertion hole for the stator 220 to pass through is provided in the moving element 230. In the case when sending electric current in the coil, the moving element 230 obtains repelling magnetic force against the magnet 224 stored in the stator 220 and moves in the axis direction of the stator 220.

The conveyance table 203 supports the optical unit 205 and moves in the axis direction of the stator 220 together with the moving element 230 fixed on the lower surface of the conveyance table 203. The straight moving guide 204 is provided on the base 202 in parallel with the stator 220 to support movement of the conveyance table 203. The linear encoder 207 is structured by a scale 271 provided in parallel with the stator 220 on the base 202 and a head 72, which moves along the scale 271 by keeping a constant distance to the scale 271. The linear encoder 207 is arranged to measure the position of the conveyance table 203.

The optical unit 205 includes a laser irradiating apparatus (not shown) for irradiating photostimulable phosphor plate 209 with laser beam while scanning the photostimulable phosphor plate 209 in the direction perpendicular to the moving direction of the optical unit 205, a light guide plate 251 for guiding photostimulable phosphor luminescence light excited by the irradiated laser beam from the laser beam irradiation apparatus to the photostimulable phosphor plate 209, a light collection tube 252 for collecting the photostimulable phosphor luminance light guided by the light guide plate 251 and a photoelectric converter 253 for converting the photostimulable phosphor luminance light collected by the light collection pipe 252.

In this image reading apparatus, a deletion apparatus (not shown) for irradiating the photostimulable phosphor plate 209 with deletion light to release X-ray energy remaining on the photostimulable phosphor plate 209 after the optical unit 205 has conducted a reading operation is provided.

A plate support section 206 supports the photostimulable phosphor plate 209, which has been used for the X-ray photographing, in parallel with direction in which the optical unit 205 moves. A latent image formed by the X-ray passed through the object has been recorded on the photostimulable phosphor plate 209. The latent image emits photostimulable phosphor luminescence light corresponding to the radiation amount when the laser beam irradiation apparatus irradiates with a laser beam. The photoelectric converter 253 converts the photostimulable phosphor luminescence light and a digital image data can be obtained. The obtained digital image data can be visualized by a certain method as a radiation image.

The external cover 208 is provided so as to cover these apparatuses. An entrance and exit port 208a for inserting and ejecting the photostimulable phosphor plate 209 to or from the apparatus is provided in the external cover 208. A stator attaching or detaching port 208b for taking out or re-inserting the stator 220 for checking is provided in the external cover.

The conveyance table 203 for loading a conveyed object is fixed in advance onto the moving element 230 in the shaft type linear motor 210 utilizing this invention. In the case when installing the shaft type linear motor 210, it is not necessary to attach the conveyance table 203 to the moving element 230 but only to attach the conveyed object onto the conveyance table 203. It is possible to install the moving element 230 into the apparatus with high accuracy without conducting adjustment by utilizing a simple structure.

Since a shaft type linear motor is utilized, it is possible to install it into the apparatus with high accuracy, particularly it is possible to obtain a superior image in the radiation image reading apparatus, in which a sever image quality is required.

1-5. (canceled)

6. An image reading apparatus for reading image information by irradiating a photostimulable phosphor plate, to which a photostimulable phosphor sheet is attached, with excitation light, the image reading apparatus comprising:
an optical unit for reading the image information by scanning and irradiating the photostimulable phosphor plate with the excitation light from a light source and converging photo-stimulated luminescence light emitted from the photostimulable phosphor plate to conduct photoelectric conversion;
a base table;
a linear motor for moving the optical unit with respect to the base table;
a wire fixed on the base table at both ends of the wire;
a pulley rotatable fixed on the optical unit for being rotated by relative movement between the pulley and the wire caused by the movement of the optical unit;
a rotary encoder for detecting a rotational speed of the pulley; and
a control section for controlling the linear motor based on a detection result of the rotary encoder;
wherein the wire is wound one turn or more around an axis of the pulley, the wire being inclined at a predetermined angle with respect to a line crossing a rotational axis of the pulley at right angle.

7. An image reading apparatus for reading image information by irradiating a photostimulable phosphor plate, to which a photostimulable phosphor sheet is attached, with excitation light, the image reading apparatus comprising:
an optical unit for reading the image information by scanning and irradiating the photostimulable phosphor plate with the excitation light from a light source and converging photo-stimulated luminescence light emitted from the photostimulable phosphor plate to conduct photoelectric conversion;
a base table;
a fixing plate for loading the photostimulable phosphor plate;
a linear motor for moving the fixing plate with respect to the base table;
a wire fixed on the base table at both ends of the wire;
a pulley rotatably fixed on the fixing plate for being rotated by relative movement between the pulley and the wire caused by the movement of the fixing plate;
a rotary encoder for detecting a rotational speed of the pulley; and
a control section for controlling the linear motor based on a detection result of the rotary encoder;
wherein the wire is wound one turn or more around an axis of the pulley, the wire being inclined at a predetermined angle with respect to a line crossing a rotational axis of the pulley at right angle.

8. The image reading apparatus of claim 6,
wherein when the predetermined angle is θ, the wire is wound around the axis of the pulley based on a following relation,
tan⁻¹(2×2r/2πR)≧θ≧tan⁻¹(2r/2πR)
where “R” denotes a radius of the wire and “R” denotes a radius of the pulley.

9. The image reading apparatus of claim 6,
wherein a rotational shaft of the rotary encoder and the pulley are integrally formed.

10. The image reading apparatus of claim 6,
wherein a surface hardness of a material of the pulley is not less than a surface hardness of a material of the wire.

11. The image reading apparatus of claim 7,
wherein when the predetermined angle is θ, the wire is wound around the axis of the pulley based on a following relation,
tan⁻¹(2×2r/2πR)≧θ≧tan⁻¹(2r/2πR)
where “r” denotes a radius of the wire and “R” denotes a radius of the pulley.

12. The image reading apparatus of claim 7,
wherein a rotational shaft of the rotary encoder and the pulley are integrally formed.

13. The image reading apparatus of claim 7, wherein a surface hardness of a material of the pulley is not less than a surface hardness of a material of the wire.
